(19) United States
(12) Patent Application Publication
(10) Pub. No.: US 2026/0085971 A1
(43) Pub. Date: Mar. 26, 2026

(54) OPTICAL MEASUREMENT SYSTEMS WITH SELECTIVE POLARIZATION

(71) Applicant: Apple Inc., Cupertino, CA (US)

(72) Inventors: Mark A. Arbore, Los Altos, CA (US); Matthew A. Terrel, Campbell, CA (US)

(21) Appl. No.: 19/323,964

(22) Filed: Sep. 9, 2025

Related U.S. Application Data
(60) Provisional application No. 63/699,558, filed on Sep. 26, 2024.

(51) Int. Cl. G01J 1/04; G01J 1/16; G01J 1/44

(52) U.S. Cl. CPC G01J 1/0429; G01J 1/0422; G01J 1/16; G01J 1/44

(57) ABSTRACT

Embodiments are directed to optical measurement systems that utilize linear polarizers to adjust the optical path distribution of light collected by the optical measurement system. The optical measurement system is configured to emit an input light beam that is linearly polarized with a launch polarization direction, and a plurality of detector elements that are positioned to measure light that is returned to the optical measurement system. The optical measurement system includes a set of linear polarizers that is positioned to linearly polarize at least some of the light collected by the optical measurement system. Each linear polarizer may adjust the optical path distribution of light incident on a corresponding detector element as compared to light that is collected for that detector element.

### CROSS-REFERENCE TO RELATED APPLICATIONS

This application claims the benefit under 35 U.S.C. § 119(e) of U.S. Provisional Patent Application No. 63/699,558, filed September 26, 2024, the disclosure of which is hereby incorporated herein by reference in its entirety.

### FIELD

The described embodiments relate generally to optical measurement systems that utilize linear polarizers to adjust an optical path distribution of light collected by the optical measurement system.

### BACKGROUND

Optical measurement systems can be used to identify the presence, type, and/or one or more characteristics of objects or substances in the environment surrounding the system. In some instances, an optical measurement system can perform spectroscopic measurements by emitting light at multiple wavelengths and measuring light returned to the system. The relative amounts of light returned at each wavelength may provide information about the nature of the material or materials being measured. The amount of light returned to the optical measurement system may additionally depend on the optical path length of light within the sample. To help improve the accuracy of measurements performed by an optical measurement system, it may be desirable to control the range and distribution of optical path lengths in a sample for light emitted and measured by the optical measurement system. As the number of wavelengths measured by an optical measurement system and the number of unique measurement locations each increase, these optical systems may require increasingly complex architectures to perform accurate measurements. Thus, a compact optical measurement system with improved optical path length control may be desired.

### SUMMARY

Embodiments described herein are directed to optical measurement systems configured adjust an optical path distribution of light collected by the optical measurement system. In some embodiments, an optical measurement system includes a light beam generator and a launch linear polarizer configured to emit a linearly polarized input light beam having a launch polarization, a plurality of detector elements including a first detector element and a second detector element, and a set of polarizers. The plurality of detector elements includes a first detector element and a second detector element, and the optical measurement system is configured to collect i) a first collected light beam for the first detector element that has a first collected optical path distribution, and ii) a second collected light beam for the second detector element that has a second collected optical path distribution different than the first collected optical path distribution. The set of linear polarizers includes a first linear polarizer positioned to linearly polarize at least a portion of the first collected light beam. Additionally, a first incident optical path distribution of light incident on the first detector element is different than the first collected optical path distribution and a second incident optical path distribution of light incident on the second detector element is the same as the second collected optical path distribution.

In some variations, the first collected light beam has a first collected median path length and the second collected light beam has a second collected median path length that is longer than the first collected median path length. In some of these variations the plurality of detector elements includes a third detector element, where the optical measurement system is configured to collect a third collected light beam for the third detector element that has a third collected optical path distribution and the third collected light beam has a third collected median path length that is longer than the second collected median path length. In some of these variations, the set of linear polarizers includes a second linear polarizer positioned to linearly polarize at least a portion of the third collected light beam. The first linear polarizer and the second linear polarizers may have orthogonal polarization directions.

Additionally or alternatively, the second linear polarizer is positioned to linearly polarize a first portion of the third collected light beam, and a second portion of the third collected light beam is not filtered by the set of linear polarizers. In some of these variations, the first portion of the third collected light beam has a shorter median path length than a median path length of the third collected light beam, and the second linear polarizer is configured to filter light having the launch polarization. Additionally or alternatively, the first linear polarizer is positioned to linearly polarize a first portion of the first collected light beam, and a second portion of the first collected light beam is not filtered by the set of linear polarizers. In some of these variations, the first portion of the first collected light beam has a shorter median path length than a median path length of the second portion of the first collected light beam, and the first linear polarizer is configured to filter light having a non-launch polarization.

Other embodiments are directed to an optical measurement system that includes a light beam generator and a launch linear polarizer configured to emit a linearly polarized input light beam having a launch polarization; a plurality of detector elements that includes a first set of detector elements, and a set of polarizers. The first set of detector elements includes a first detector element and a second detector element, and the optical measurement system is configured to collect a first set of collected light beams for the first set of detector elements. The first set of collected light beams includes: i) a first collected light beam that has a common first collected optical path distribution and is collected for the first detector element of the first set of detector elements; and ii) a second collected light beam that has the common first collected optical path distribution and is collected for the second detector element of the first set of detector elements. The set of linear polarizers includes a first linear polarizer positioned to linearly polarize at least a portion of the first collected light beam of the first set of collected light beams.

In some variations, the set of linear polarizers includes a second linear polarizer positioned to linearly polarize at least a portion of the second collected light beam of the first set of collected light beams. In some of these variations, the first linear polarizer and the second linear polarizer have orthogonal polarization directions. The first detector element of the first set of detector elements may outputs a first measurement signal, the second detector element of the first set of detector elements may output a second measurement signal, and the optical measurement system may be configured to electrically combine the first measurement signal and the second measurement signal to generate a combined measurement signal. In some of these variations, the optical measurement system includes an operational amplifier, wherein a first input of the operational amplifier receives the first measurement signal, a second input of the operational amplifier receives the second measurement signal, and an output of the operation amplifier generates the combined measurement signal.

Additionally or alternatively, the first set of detector elements includes a third detector element, and the first set of collected light beams includes a third collected light beam that has the common first collected optical path distribution and is collected for the third detector element of the first set of detector elements. In some of these variations, light incident on the third detector element of the first set of detector elements has an incident optical path distribution that is the same as the common first collected optical path distribution. Additionally or alternatively, the plurality of detector elements includes a second set of detector elements, and the optical measurement system is configured to collect a second set of collected light beams for the second set of detector elements. In these variations, the second set of collected light beams may have a common second optical path distribution different than the common first optical path distribution.

Still other embodiments are direct to optical measurement systems that include a light beam generator and a launch linear polarizer configured to emit a linearly polarized input light beam having a launch polarization, a first condenser lens, a set of polarizers, and a plurality of detector elements including a first set of detector elements positioned to receive light from the first condenser lens. The first set of detector elements includes a first detector element and a second detector element, and the optical measurement system is configured to collect: i) a first collected light beam for the first detector element of the first set of detector elements, and ii) a second collected light beam for the second detector element of the first set of detector elements. The set of linear polarizers includes a first linear polarizer positioned to linearly polarize at least a portion of the first collected light beam. In some of these variations, the first collected light beam and the second collected light beam each have a common first optical path distribution. Additionally or alternatively, the plurality of detector elements includes a second set of detector elements positioned to receive light from the first condenser lens.

In addition to the example aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a cross-sectional side view of a device incorporating an optical measurement system as described herein. FIG. 1B shows a top view of the device of FIG. 1A.

FIG. 2A shows a partial cross-sectional side view of an optical measurement system, such as described herein, that is configured to collect light having a different path length distribution for each detector element of an array of detector elements. FIG. 2B shows a plot of example path length distributions for light collected by the optical measurement system of FIG. 2A. FIGS. 2C and 2D show top views of a sampling interface of variations of the optical measurement system of FIG. 2A. FIGS. 2E and 2F show partial top views of variations of the optical measurement system of FIG. 2A.

FIG. 3 shows a partial cross-sectional side view of a variation of an optical measurement system as described herein.

FIG. 4A shows a partial cross-sectional side view of a variation of an optical measurement systems as described herein that include one or more condenser lenses. FIGS. 4B and 4C show cross-sectional side views of variations of detector assemblies that may be used with the optical measurement system of FIG. 4A.

FIGS. 5A and 5B show top views of variations of optical measurement systems that have a set of linear polarizers as described herein. FIG. 5C shows a plot of example path length distributions of light collected for and light measured by, respectively, of a detector element when the collected light is filtered using a first configuration of linear polarizer. FIG. 5D shows a plot of example path length distributions of light collected for and light measured by, respectively, of a detector element when the collected light is filtered using a first configuration of linear polarizer.

FIGS. 6A and 6B show partial top views of variations of optical measurements systems that include a set of detector elements each having a common collected optical path distribution.

FIGS. 7, 8, and 9A-9C show partial top views variations of optical measurement systems having different configurations of detector elements and linear polarizers.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto. It should be also be understood that in figures that show cross-sectional side views, certain components (e.g., launch sites, collection sites, lenses, detector assemblies) may be illustrated without hatching to aid in visualization of the overall optical measurement system (e.g., to facilitate viewing the trajectory of light traversing the optical measurement system).

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to embodiments of optical measurement systems that are configured to perform spectroscopic measurements. Specifically, the optical measurement systems described herein include a plurality of detector elements positioned in an array, where each detector element is used to measure a different portion of light collected by the optical measurement system. The optical measurement system is configured to collect, for each detector element, light having a corresponding optical distribution, where the optical path distribution includes a path length distribution and a sampling depth distribution. The optical measurement system further includes one or more linear polarizers configured to filter, and thereby linearly polarize, at least a portion of a light beam that is collected for one or more detector elements. In this way, at least a portion of the light beams that are incident on the detector element (and thereby measured by the detector element) is linearly polarized. These linear polarizers may adjust the path length distribution and/or sampling depth distribution of light measured by these detector elements, and thereby change the optical path distribution of light measured by the detector elements relative to the optical path distribution of light collected for the detector elements. This may facilitate the performance of spectroscopic measurements using a compact arrangement.

To perform a spectroscopic measurement on a sample, the optical measurement systems described herein may perform a measurement sequence of individual measurements. During each individual measurement, the optical measurement system may emit input light in the form of an input light beam that is directed into a region of the sample. While emitting the input light, the optical measurement system measures light that returns from the sample using a corresponding set of detector elements of the plurality of detector elements. Each individual measurement may measure light using all of the detector elements or a corresponding subset of the detector elements as may be desired. Each detector element may output a corresponding measurement signal during an individual measurement that represents the amount of light that is measured by the detector element during that individual measurement. Collectively, the measurement signals generated during an individual measurement may provide an indication of the relative amount of the input light that is returned to the optical measurement system for each of the detector elements that are used during that measurement. In some instances, the measurement signals generated by different detector elements may be combined together, such that these output signals are combined into a single combined measurement signal. It should be appreciated that these measurement signals may be combined electrically (e.g., the electrical signals from multiple detector elements are combined such that a controller or processor analyzing the output signals receives a single electrical signal) or may be combined digitally (e.g., the controller or processor analyzing the various measurement signals receives the individual measurement signals, and digitally combines them such that they are treated as a single output signal for the purpose of sample analysis).

Because light of different wavelengths may interact differently with a given sample, it may be desirable for the measurement sequence to include multiple individual measurements performed at different wavelengths. In these instances, the input light beam may include light of different wavelengths during different individual measurements. In some instances, the optical measurement system may be configured to emit an input light beam having a single wavelength for certain individual measurements. In this way, the measurement sequence may include one or more individual measurements performed using a single wavelength (e.g., a first individual measurement that uses input light of a first wavelength, a second individual measurement that uses input light of a second wavelength, and so on). Additionally or alternatively, the optical measurement system may be configured to emit an input light beam that simultaneously includes multiple wavelengths of light for certain individual measurements. In these instances, the measurement sequence may include one or more individual measurements performed using multiple wavelengths (e.g., a first individual measurement that uses an input light beam having a first plurality of wavelengths, a second individual measurement that uses an input light beam having a second plurality of wavelengths, and so on). Information about the wavelength (or wavelengths) associated with each individual measurement may be used by the optical measurement system in determining one or more properties of the sample. In some variations, the one or more properties may include an estimate of the concentration of a particular substance within the sample.

Overall, the measurement sequence will include a set of individual measurements that measure one or more regions of a sample using one or more wavelengths (collectively referred to as the “measurement wavelengths” of the spectroscopic measurement). This will result in one or more measurement signals being generated for each individual measurement, and thus the overall spectroscopic measurement may generate a plurality of measurement signals using the plurality of detector elements. These measurement signals may be analyzed to derive one or more properties of the sample (e.g., using spectroscopic analysis techniques). It should be appreciated that the optical measurement systems described herein are not intended to be limited to a particular type of sample or spectroscopic measurement, and that one of ordinary skill in the art would readily understand that the principles of the optical measurement systems described herein may be used with a wide range of analytical techniques to determine one or more properties associated with a sample.

When the optical measurement system emits an input light beam into a sample, the relative amount of this light that is returned to the optical measurement system for a given individual measurement may depend on the sample being measured, and may thereby provide information about one or more properties of the sample. Specifically, a portion of the input light beam introduced into a sample may be absorbed as it travels through the sample. The amount of light absorbed depends at least in part on the contents of the sample (e.g., the presence and concentration of different substances within the sample) as well as the optical path length of the light (e.g., the length that light travels within the sample). In some instances, the amount of absorbance may also depend at least in part on how deep into a sample the light travels.

For example, certain aspects of sample may vary as a function of sample depth. A sample measured by the optical measurement system may be at least partially defined by a set of sample characteristics, that may include at least a scattering coefficient (e.g., a reduced scattering coefficient), an absorption coefficient, and a refractive index. In some instances, a sample may have multiple layers, where each layer has different characteristics. In this way, different portions of a sample (e.g., different layers of a multi-layer sample) may have different sample characteristics. For example, a first layer of a sample may have a first absorption coefficient and a second layer of the sample may have a different second absorption coefficient. Light may interact differently with the sample depending on how deep the light penetrates into the sample.

Depending on the design of the optical measurement system and the characteristics of the sample being measured, each detector element will collect light that traverses a corresponding range of path lengths and sampling depths. For example, the optical measurement systems may be configured to measure a volume-scattering sample. In these instances, light that is introduced into the sample from the optical measurement system will scatter one or more times within the sample before returning to the optical measurement system. Individual photons may scatter differently within a volume-scattering sample, and thus each photon measured by a detector element may travel a different corresponding path (with a corresponding path length and depth) through the sample. Accordingly, light collected by the optical measurement system may be associated with a corresponding “optical path distribution,” which represents the combination of a path length distribution and a sampling depth distribution of the collected light. As used herein, “path length distribution” of light refers to a probability distribution that represents the likelihood that a photon of light introduced into a sample from the optical measurement system and collected by the optical measurement system has a particular optical path length for a given sample. Similarly, a “sampling depth distribution” of light refers to a probability distribution that represents the likelihood that a photon of light introduced into a sample from the optical measurement system and collected by the optical measurement system has penetrated to a particular sample depth in a given sample.

The characteristics of the path length distribution and/or sampling depth distribution of light collected by an optical measurement system and measured by a given detector element thereof may impact the accuracy of measurement signals generated by that detector element. Wide variations in the range of measured optical path lengths may make it more difficult to accurately measure certain sample properties (e.g., the presence and/or concentration of a particular substance within the sample). For example, a narrower distribution (i.e., with less dispersion) may provide higher confidence that light measured by the detector element has a particular optical path length. Accordingly, it may be desirable to tailor the design of an optical measurement system such that a given detector element measures light having a narrow path length distribution for a given sample, which may thereby improve the accuracy of measurements performed by the optical measurement system. Depending on the sample, it may also be desirable to measure light having a narrower sampling depth distribution, which may provide higher confidence that light measured by a given detector element has penetrated to a particular depth within the sample.

It should be appreciated that the optical path distribution of light measured by a detector element depends on the design of the optical measurement system and may vary based on the sample characteristics (e.g., the scattering coefficient, the absorption coefficient, and the refractive index) of the sample being measured. The optical measurement systems described herein may be designed to measure a particular type of sample, which may have sample characteristics that may vary from sample to sample. The optical measurement system may be designed and operate under the assumption that a sample being measured has a particular set of sample characteristics (e.g., a scattering coefficient within a target range of scattering coefficients, an absorption coefficient within a target range of absorption coefficients, and a refractive index within a target range of refractive indices).

By incorporating linear polarizers into the optical measurement systems described herein, one or more aspects of the optical path distribution (e.g., the path length distribution and/or the sampling depth distribution) of light measured by certain detector elements may be adjusted to improve the accuracy of the spectroscopic measurements. In some instance, the incorporation of linear polarizers may help to identify or otherwise account for sample-to-sample differences in certain sample characteristics, such as a scattering coefficient of a sample.

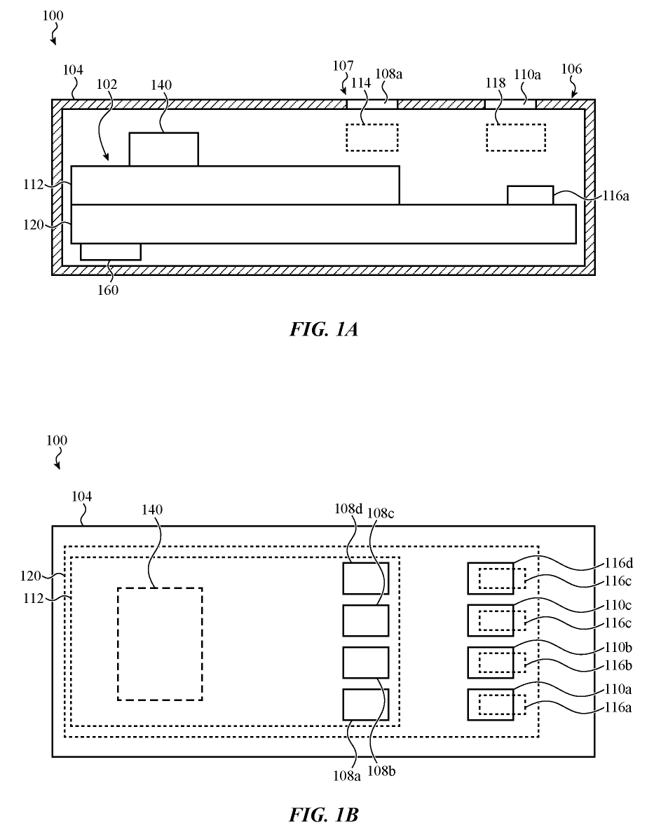

These and other embodiments are discussed below with reference to FIG. 1A–9C. However, those skilled in the art will readily appreciate that the detailed description given herein with respect to these Figures is for explanatory purposes only and should not be construed as limiting.

The embodiments of the optical measurement systems described herein may be incorporated into a device having a housing. The device, which in some instances is wearable, may operate solely to take measurements using the optical measurement system or may be a multi-functional device capable of performing additional functions, such as will be readily understood by someone of ordinary skill in the art. For example, in some instances the optical measurement system may be incorporated into a smart phone, tablet computing device, laptop or desktop computer, a smartwatch, earphone, headset, head-mounted device, or other wearable, or other electronic device (collectively referred to herein as “electronic devices” for ease of discussion).

The electronic device may include a display (which may be a touchscreen display) that provides a graphical output that is viewable through or at an exterior surface of the device. When the display is configured as a touchscreen, the display may be capable of receiving touch inputs at the exterior surface. The device may include a cover sheet (e.g., a cover glass) positioned over the display that forms at least a portion of the exterior surface. The display is capable of providing graphical outputs and, when configured as a touch screen, receiving touch inputs through the cover sheet. In some embodiments, the display includes one or more sensors (e.g., capacitive touch sensors, ultrasonic sensors, or other touch sensors) positioned above, below, or integrated with the display portion. In various embodiments, a graphical output of the display is responsive to inputs provided to the electronic device. The portable electronic device may include additional components typical of computing devices, including a processing unit, memory, input devices, output devices, additional sensors, and the like.

FIGS. 1A and 1B show an example of a device 100 that houses an optical measurement system 102 as described herein. FIG. 1A shows a side view of a device 100 comprising, for example, a housing 104 having a top exterior surface 106 (the housing 104 is depicted as a cross-section in FIG. 1A to reveal a side view of components of the optical measurement system 102 that are positioned within the housing 104). This top exterior surface 106 defines a sampling interface 107 for the optical measurement system 102, through which light generated by the optical measurement system 102 can be emitted from the optical measurement system 102 and the device 100. Light may also pass through the sampling interface 107 to re-enter the optical measurement system 102 and the device 100. While the same surface of the device 100 is used as a sampling interface 107 for emission and collection of light from the optical measurement system, it should be appreciated that the sampling interface 107 may span multiple surfaces of the device 100 such that light may be emitted and/or collected from different surfaces of the device 100 (e.g., light is emitted from the optical measurement system 102 at a portion of the sampling interface 107 on a first surface of the device 100 and light is collected by the optical measurement system 102 at a second sampling interface at a second portion of the sampling interface 107 on a second surface of the device 100). Additionally or alternatively, light may be emitted from multiple different surfaces of the device 100 and/or collected from multiple different surfaces of the device 100.

The sampling interface 107 includes at least one window that defines a set of launch sites 108a-108d of the optical measurement system 102 and a set of collection sites 110a-110d of the optical measurement system 102. In the variation shown in FIGS. 1A and 1B, the device includes a plurality of launch sites 108a-108d and a plurality of collection sites 110a-110d. While FIGS. 1A and 1B depict an equal number (e.g., four) of launch sites 108a-108d and collection sites 110a-110d, in other instances the sampling interface 107 has an unequal number of launch sites 108a-108d and collection sites 110a-110d. Each window that defines a launch site and/or a collection site is transparent at any wavelength or wavelengths used by the optical measurement system 102 to perform a measurement using that launch site and/or collection site. For example, in order for a given detector element to measure a particular wavelength of light, a window associated with launch site is transparent at this wavelength to allow for the light to be emitted from the optical measurement system 102, and a window associated with a collection site is transparent at this wavelength to allow for the light to be returned to the optical measurement system 102.

In some instances, each of the set of launch sites 108a-108d and each of the collection sites 110a-110d is defined by a different corresponding window. For example, a first launch site 108a may be defined by a first window, a second launch site 108b may be defined by a second window, a first collection site 110a may be defined by a third window, a second collection site 110b may be defined by a fourth window, and so on. In these instances, the individual windows defining the various launch sites and collections sites may be separated from each other by one or more opaque portions of the housing (i.e., that absorb or otherwise block light transmission at the measurement wavelengths used by the optical measurement system 102). In other variations, some or all of the launch sites 108a-108d and/or collection sites 110a-110d are defined in a common window (e.g., using a mask that is opaque at the measurement wavelengths that is deposited on the window to define apertures that form the various launch sites and/or collection sites). Additionally or alternatively, the device 102 may include barriers, baffles, or other light-blocking structures (not shown) that may at least partially define some or all of the launch sites 108a-108d and collection sites 110a-110d. These light-blocking structures may block stray light and act as a guide to limit the paths that light can take within the optical measurement system 102 before reaching a given launch site at the sampling interface 107 or reaching a detector element after entering the optical measurement system 102 at the sampling interface 107 through a collection site.

The optical measurement system 102 is capable of generating light and emitting light through the set of launch sites 108a-108d during a spectroscopic measurement. Specifically, the optical measurement system 102 may include a light source unit 140 that is configured to generate light in a range of wavelengths (including the measurement wavelengths used to perform the various individual measurements of the spectroscopic measurement). The light source unit 140 includes a set of light sources (not shown), each of which is selectively operable to emit light at a corresponding set of wavelengths. Each light source may be any component capable of generating light at one or more particular wavelengths, such as a light-emitting diode or a laser. A laser may include a semiconductor laser, such as a laser diode (e.g., a distributed Bragg reflector laser, a distributed feedback laser, an external cavity laser), a quantum cascade laser, or the like. A given light source may be single-frequency (fixed wavelength) or may be tunable to selectively generate one of multiple wavelengths (e.g., the light source may be controlled to output different wavelengths at different times). The set of light sources may include any suitable combination of light sources, and collectively may be operated to generate light at any of a plurality of different wavelengths.

To the extent the light source unit 140 is capable of generating multiple different wavelengths, the light source unit 140 may be configured to generate different wavelengths of light simultaneously and/or sequentially. In some instances, such as the variation shown in FIGS. 1A and 1B, the optical measurement system 102 comprises a photonic integrated circuit 112. In these instances, the light source unit 140 may be integrated into a photonic integrated circuit 112 or may be separate from the photonic integrated circuit 112 and couple light into the photonic integrated circuit 112.

The photonic integrated circuit 112 routes light generated by the light source unit 140, and launches light from the photonic integrated circuit 112 to form one or more light beams. For example, the photonic integrated circuit 112 may include one or more outcouplers (e.g., an edge coupler, a vertical output coupler, or the like) for launching light from the photonic integrated circuit 112. The photonic integrated circuit 112 may be configured to emit a single light beam or may be configured to emit multiple light beams. For example, in instances where the sampling interface 107 includes multiple launch sites 108a-108d, it may be desirable for the photonic integrated circuit 112 to emit a different input light beam for each individual launch site of the set of launch sites 108a-108d (e.g., a first input light beam for the first launch site 108a, a second input light beam for the second launch site 108b, and so on). For example, the optical measurement system 102 may be divided into multiple measurement subsystems, each of which may be independently operated to perform individual measurements. In these instances, different launch sites 108a-108d may be associated with different measurement subsystems, which may allow the optical measurement system 102 to perform individual measurements at different locations of a measured sample without needing to move the device 100 relative to the sample.

In some of these variations, the optical measurement system may individually control the timing and/or properties of some or all of the light beams emitted from the photonic integrated circuit 112. Specifically, in some instances the emission of different light beams from the photonic integrated circuit 112 is individually controllable. For example, the photonic integrated circuit 112 may be controllable to selectively launch a first set of light beams independently of a second set of light beams. Accordingly, at any given time the optical measurement system 102 may control whether i) only the first set of light beams (and not the second set of light beams) is launched from the photonic integrated circuit 112, ii) only the second set of light beams (and not the first set of light beams) is launched from the photonic integrated circuit 112, or iii) in instances when the photonic integrated circuit 112 is capable of emitting both sets of light beams simultaneously, both the first and the second sets of light beams are simultaneously launched by the photonic integrated circuit 112. Additionally or alternatively, the photonic integrated circuit 112 may be able to generate light beams with different light properties, such as intensity, phase, and/or wavelength. Overall, individual control of different beams or different groups of beams may reduce the amount of stray light that is lost within the optical system, may allow for selective control of light emission through the individual launch sites 108a-108d (e.g., allowing some launch sites to emit light while other launch sites are not actively emitting light), and/or may allow for light properties such as intensity, phase, or wavelength to be selectively varied between different launch sites 108a-108d.

It should be appreciated that in some variations, the optical measurement system 102 may include multiple photonic integrated circuits, each of which may include a different corresponding light source unit. In these instances, different photonic integrated circuits may be used to generate different light beams. The different photonic integrated circuits may be used to direct input light beams to different subsets of the launch sites 108a-108d (e.g., as part of different measurement subsystems or different groups of measurement subsystems), which may provide flexibility in routing input light beams to different launch sites 108a-108d. While photonic integrated circuits may present a compact form factor for generating and manipulating light emitted by the optical measurement system 102, it should be appreciated that the principles described herein may be applied to optical measurement systems that do not utilize photonic integrated circuits to generate and emit light.

The optical measurement system 102 may include additional light modification components between the photonic integrated circuit 112 and the sampling interface 107. These light modification components collectively act to route light from the photonic integrated circuit 112 to the various launch sites 108a-108d. For example, these light modification components may act to redirect, combine (e.g., such that multiple light beams launched from the photonic integrated circuit 112 are combined into a single input light beam), split (e.g., such that a single light beam is split into multiple individual input light beams), change the divergence of, reshape, or otherwise modify the light beams launched from the photonic integrated circuit 112. Examples of light modification components include lenses (which change the divergence and/or direction of a light beam), diffusers, mirrors, beamsplitters, or the like. For the purpose of illustration, a first set of optical components is depicted schematically as box 114 positioned between the photonic integrated circuit 112 and the sampling interface 107. It should be appreciated that in some instances the sampling interface 107 itself may act as a light modification component (e.g., it may have an integrated lens or the like that can change the divergence and/or direction of the light passing therethrough). Collectively, the photonic integrated circuit 112, the sampling interface 107, and any intervening light modification components 114 may at least partially determine the characteristics of light emitted from each of the launch sites 108a-108d as input light beams.

The optical measurement system further comprises one or more detector groups 116a-116d, each of which includes a corresponding set of detector elements. Each of the one or more detector groups 116a-116d is positioned within the device 100 to receive light that has entered the device 100 (and thereby the optical measurement system 102) through the sampling interface 107 (e.g., via one or more collection site of the set of collection sites 110a-110d). Each of the one or more detector groups 116a-116d includes one or more detector elements configured to measure light received by the optical measurement system 102 (e.g., light that has been emitted from the optical measurement system into a measured sample and returned to the optical measurement system) during a measurement. Each detector element is capable of generating an output signal that represents an amount of light measured by that detector element. In this way, the output signal of a detector element during an individual measurement may act as the measurement signal for that detector element. Accordingly, a detector group that includes multiple detector elements may generate multiple corresponding measurement signals during a given individual measurement.

It should be appreciated that in some instances the output of two or more detector elements may be combined, such that the signals generated by the two or more detector elements are combined into a single combined measurement signal, such as described in more detail herein. Overall, the light measured by the set of detector groups during a measurement sequence of individual measurement may be analyzed to determine one or more properties of the sample being measured. Light measured by a given detector element while the optical measurement system is emitting an input light beam (e.g., via a corresponding launch site of the sampling interface 107) how the emitted light interacts with the sample before returning to the optical measurement system 102, which depends at least partially on the characteristics and properties of the sample being measured. Light may optionally also be measured by a given detector element while the optical measurement system is not actively emitting light, which may measure background light incident on the detector element and/or dark current for use in a background correction operation.

In some variations the optical measurement system 102 comprises one or more light modification components positioned between the sampling interface 107 and one or more of the detector groups 116a-116d. These light modification components collectively act to route light from the various collection sites 110a-110d to the detector groups 116a-116d. For example, these light modification components may act to redirect, combine (e.g., such that multiple light beams collected by one or more collection sites 110a-110d are combined into a single collected light beam), split (e.g., such that a single collected light beam is split into multiple individual collected light beams), change the divergence of, reshape, or otherwise modify the light beams collected by the set of collection sites 110a-110d. Examples of light modification components include lenses (which change the divergence and/or direction of a light beam), diffusers, mirrors, beamsplitters, or the like. For the purpose of illustration, a second set of light modification components is depicted schematically in FIG. 1A as box 118 positioned between the sampling interface 107 and the one or more detector groups 116a-116d.

For each of the set of collection sites 110a-110d, the light modification components 118 may control how light entering the optical measurement system 102 via that collection site is routed to one or more detector elements of the detector groups 116a-116d. As an example, if light entering a first collection site 110a has a first set of characteristics (e.g., enters the optical measurement system 102 with a particular combination of location of the first collection site 110a, angle of incidence, and direction) it may be routed by the light modification components 118 to a first detector element (e.g., a first detector element of a first detector group 116a). If light entering the first collection site 110a has a different second set of characteristics (e.g., a different combination of entry location, angle of incidence, and direction), it may be routed to a second detector element (e.g., a second detector element of the first detector group 116a), and so on. The optical path distribution of light entering the optical measurement system 102 depends on the characteristics of the light as it enters a given collection site. For example, light entering the first collection site 110a with the first set of characteristics will have a first optical path distribution, and light entering the first collection site 110a with the second set of characteristics will have a second optical path distribution. Depending on the sets of characteristics, the first and second optical path distributions may be the same or may have different path length and/or sampling depth distributions.

Because the optical measurement systems described herein utilize linear polarizers to at least partially control light that reaches detector elements, it should be appreciated that not all of the light that is routed toward a particular detector element will actually reach and be measured by that detector element. For the purpose of this application, the terms “collected light” and “light collected for”, when used in reference to a particular detector element, refer to light that is collected by the optical system and that is directed toward that detector element, regardless of whether some of that light is filtered by a linear polarizer prior to reaching the detector element. The terms “incident light” and “light incident on”, when used in reference to a particular detector element, refer to light that is collected by the optical system and that reaches the detector element. Accordingly, when generating an output signal, a detector element measures the light incident on that detector element.

For a given detector pixel, the incident light for a detector element may include some or all of the light collected for that detector element, depending on whether the collected light passes through a linear polarizer prior to reaching the detector element. If the collected light for a detector does not pass through any linear polarizers, the detector element will measure all of the collected light (e.g., the incident light is the same as the collected light). Conversely, if some or all of the collected light passes through a linear polarizer, some of this light may (depending on the polarization of the collected light entering the optical measurement system) be absorbed and/or reflected by the linear polarizer and will not reach the detector element. In these instances, the incident light may be a subset of the collected light for the detector element. Accordingly, the terms “collected light” and “incident light” are used herein to illustrate how linear polarizers may alter the characteristics of light before it is measured by a detector element. Returning to the example of FIGS. 1A and 1B, in instances where light entering the first collection site 110a with a first set of characteristics is routed toward a first detector element, the light entering the first collection site 110a with this first set of characteristics is considered to be the light collected for the first detector element. The light that reaches the first detector element (and can be measured thereby) is the incident light for the first detector. The incident light on the first detector will either be all of the collected light (in instances where the collected light does not pass through a linear polarizer of the optical measurement system) or a subset of the collected light (in instances where at least a portion of the collected light passes through a linear polarizer of the optical measurement system).

It should be appreciated that the optical measurement systems described herein may include one or more additional components (separate from a linear polarizer) that may control what light ultimately reaches a given detector element. For example, in some variations the optical measurement system 102 may include one or more filters (not shown) that are configured to remove light having a particular set of wavelengths (e.g. “filtered wavelengths”) and are positioned to prevent the filtered wavelengths from reaching a particular detector element. In these instances, because the filtered wavelengths would not reach the detector element regardless of whether the light passed through a linear polarizer of the optical measurement system 102, light of the filtered wavelengths would not be considered part of the light collected for that detector element.

In some instances in which the optical measurement system 102 includes a photonic integrated circuit 112, the photonic integrated circuit 112 and one or more of the detector groups 116a-116d are mounted to a common component. For example, in the variation shown in FIGS. 1A and 1B, the optical measurement system 102 comprises an interposer 120. In these instances, the photonic integrated circuit 112 and one or more of the detector groups 116a-116d are mounted on the interposer 120, which in turn may act as an electrical interface for these components (e.g., to route power, control, and/or other signals to and/or from the components). In some instances, the interposer also acts as a heat sink. In variations where the optical measurement system 102 includes multiple photonic integrated circuits, some or all of the photonic integrated circuits may be mounted on the interposer 120. In other variations, the photonic integrated circuit 112 is mounted to a separate component than some or all of the detector groups 116a-116d. In still other variations, some or all of the detector groups 116a-116d are directly mounted on (or otherwise integrated into) a portion the photonic integrated circuit 112.

Also shown in FIG. 1A is a controller 160. The controller 160 is configured to control the operation of the optical measurement system 102 to perform a spectroscopic measurement. Specifically, the controller 160 is operatively coupled to various components of the optical measurement to control operation thereof. For example, the controller 160 may be operatively connected to the light source unit 140 and may control the light source unit 140 to generate light at one or more wavelengths as needed during the individual measurements of a spectroscopic measurement. Similarly, the controller 160 may be operatively connected to the one or more detector groups 116a-116d to receive the output signals generated by the various detector elements, which are received by the controller 160 as measurement signals during a given individual measurement. Indeed, the controller 160 may control the operation of any active component (e.g., controllable phase shifters, optical switches, moving components, or the like) during a spectroscopic measurement. Additionally, the controller 160 may be configured to process the measurement signals generated during a spectroscopic measurement to determine one or more properties of a sample being measured.

The controller 160 may include any suitable combination of hardware, software, and/or firmware as may be necessary to control the various operations of the optical measurement system 102. For example, the controller 160 may include one or more processors and memory. Memory can include one or more non-transitory computer-readable storage mediums, for storing computer-executable instructions, which, when executed by one or more computer processors, for example, can cause the computer processors to perform the techniques that are described here (such as controlling the individual components of the optical measurement system 102 to perform a spectroscopic measurement). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs, as well as persistent solid-state memory such as flash, solid-state drives, and the like.

Similarly, the one or more processors can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and operation of the optical measurement system 102. The specific details and arrangements of a controller 160 that may control the various operations of the optical measurement system 102 will readily be understood by one of ordinary skill in the art, and thus will not be described in further detail herein.

In some instances, the controller 160 may control the optical measurement system 102 to perform a measurement of sample and analyzes the resulting measurement signals to determine one or more properties of the sample. In these instances, the device 100 may be operable to perform a complete spectroscopic measurement without requiring interaction with other devices of a larger system. In other instances, the controller 160 may operate in conjunction with one or more processors from an additional device (separate from the device 100) to perform a spectroscopic measurement and/or analyze the resulting measurement signals. For example, the controller 160 may receive instructions from a processor of an additional device (e.g., transmitted from the additional device) that select one or more parameters of a spectroscopic measurement (e.g., the number of individual measurements, the duration of one or more individual measurements, and/or the wavelengths associated with certain individual measurements) and the controller 160 may control the optical measurement system 102 to perform the measurement according to these selected parameters. Additionally or alternatively, a processor of an additional device may receive (e.g., via transmission from the device 100) the measurement signals generated by the spectroscopic measurement, and may analyze the measurement signals to determine the one or more properties of the sample. In this way, some or all of the processing of the spectroscopic measurement may be offloaded to another device, which may save the device 100 processing time and/or reduce power consumption by the device 100.

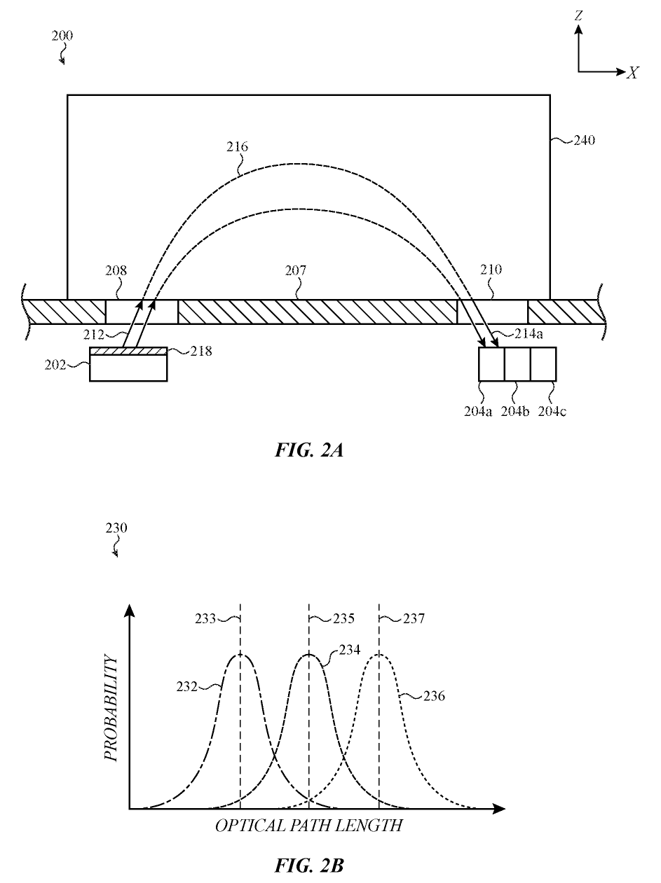

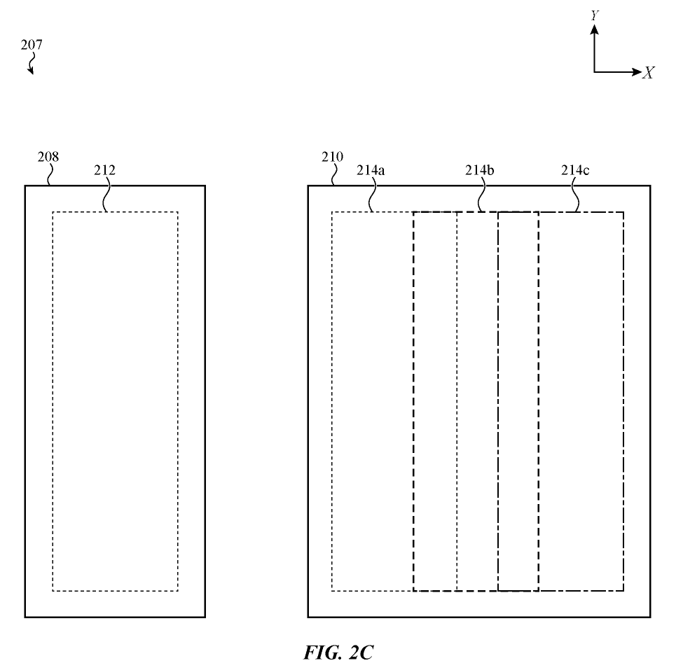

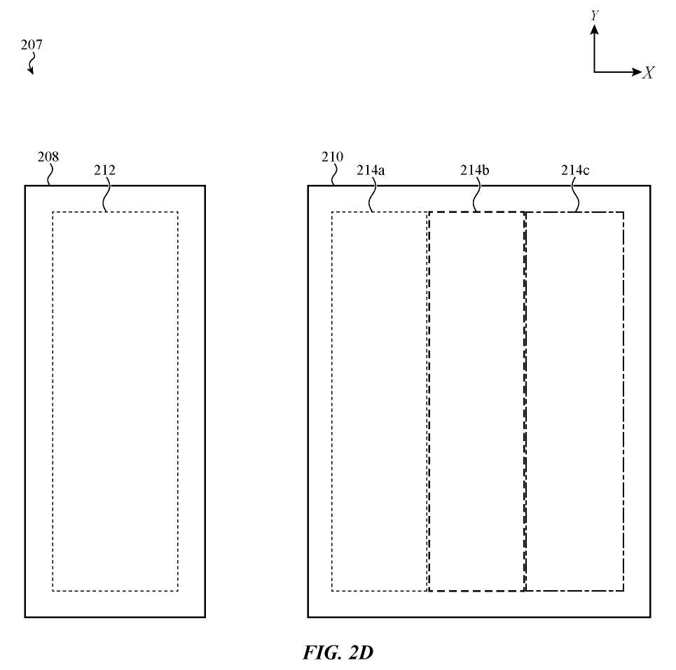

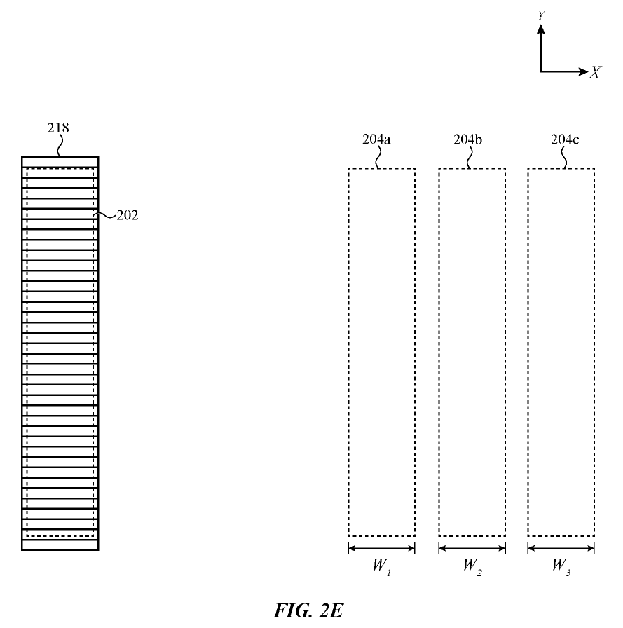

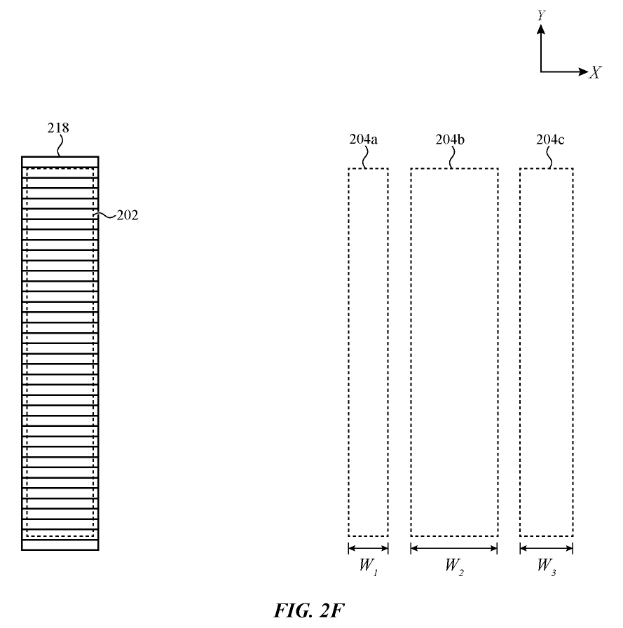

FIGS. 2A-2F illustrate how the design of an optical measurement system as described herein may impact the path length distribution of light collected for and incident on a detector element. Specifically, FIG. 2A shows a cross-sectional side view of a portion of an optical measurement system 200 as described herein. Also shown in FIG. 2A is a sample 240 that may be measured by the optical measurement system 200. The optical measurement system 200 may be configured in any manner as described herein with respect to the optical measurement system 102 of FIGS. 1A and 1B. Specifically, the optical measurement system 200 includes a sampling interface 207 defining a launch site 208 and a collection site 210, and is configured generate an input light beam 212 that exits the sampling interface 207 through the launch site 208. The optical measurement system 200 includes a light beam generator 202 that generates the input light beam 212. While represented schematically in FIG. 2A as a box, the light beam generator 202 may represent any set of components (e.g., such as those described with respect to the optical measurement system 102 of FIGS. 1A and 1B) that are used to generate and shape an input light beam 212 before it exits the sampling interface 207. The light beam generator 202 includes a linear polarizer 218 (referred to herein as a “launch linear polarizer”) that is positioned to polarize the input light beam 212 before it exits the sampling interface 207. The launch linear polarizer 218 that is configured to pass light having a first polarization direction (also referred to herein as the “launch polarization”) and filter out light having a second polarization state orthogonal to the launch polarization (also referred to herein as “the non-launch polarization”). Accordingly, the input light beam 212 is linearly polarized as it exits the sampling interface 207 having a first polarization. While the launch linear polarizer 218 is shown in FIG. 2A as being separate from the light beam generator 202, it should be appreciated that the launch linear polarizer 218 may be incorporated into the optical measurement system 200 in any suitable manner so long as the input light beam 212 is linearly polarized as it exits the sampling interface 207. For example, the optical measurement system 200 may include one or more lenses or other optical components that are positioned between the launch linear polarizer 218 and the sampling interface 207, such that these components further shape and/or redirect the input light beam 212 i) after the input light beam 212 has passed through the launch linear polarizer 218 and ii) before the input light beam 212 exits the optical measurement system 200 through the sampling interface 207.

It should be appreciated that in some variations, depending on the design of the optical measurement system 200, the light beam generator 202 may be configured without the launch linear polarizer 218. For example, depending on the light sources used to generate the light that forms the input light beam 212, as well as the other components use to route and shape this light, the input light beam 212 may be at least partially linearly polarized.

The optical measurement system 200 further includes an array of detector elements 204a-204c, wherein each detector element of the array of detector elements 204a-204c is configured to measure a corresponding light beam collected by the optical measurement system 200. In the example shown in FIG. 2A, the array of detector elements 204a-204c includes three detector elements (e.g., a first detector element 204a, a second detector element 204b, and a third detector element 204c), though it should be appreciated that in other instances the array of detector elements 204a-204c may include a plurality of detector elements with a different number of detector elements (e.g., two or four or more detector elements). The optical measurement system 200 is configured to collect, for each of the array of detector elements 204a-204c, a corresponding collected light beam that enters the optical measurement system 200 through the collection site 210 and is directed to the respective detector element. For example, FIG. 2A shows a first collected light beam 214a that is collected for the first detector element 204a.

The input light beam 212 may have particular beam properties as it exits the launch site 208, including a launch location (e.g., the lateral position of the input light beam 212 relative to the launch site 208), beam size (e.g., the dimensions of the input light beam 212 as it exits the launch site 208), beam shape (e.g., the cross-sectional shape of the input light beam 212 as it exits the launch site 208), and beam vergence (e.g., the amount of divergence of the input light beam 212 as it exits the launch site 208). Additionally, the input light beam 212 will be linearly polarized by virtue of passing through the launch linear polarizer 218. When a measured sample 240 is placed against the sampling interface 207, such as shown in FIG. 2A, the input light beam 212 will have these beam properties as it enters the sample 240. It should be appreciated that the light of the input light beam 212, after entering the sample 240, may change properties (e.g., direction, polarization) as it interacts with the sample 240.

Similarly, the first collected light beam 214a will also have a first set of beam properties (e.g., a beam size, a beam shape, a beam vergence, and an exit location relative the collection site 210) as it exits the sample 240 and enters the collection site 210. Light that does not have the first set of beam properties as it enters the collection site 210 will not be directed to the first detector element 204a, though some of this light may be collected for and directed to other detector elements of the array of detector elements 204a-204c. Collectively, the beam properties of the input light beam 212 and the beam properties of the first collected light beam 214a may at least partially determine the optical path distribution, for a given sample, of light that is collected for the first detector element 204a. Additionally, the light of the first collected light beam 214a, by virtue of interacting with the sample 240, will be at least partially depolarized as compared to input light beam 212.

For example, when the optical measurement system 200 is used to measure a sample 240 as shown in FIG. 2A, the input light beam 212 will penetrate into the sample 240 as it exits the sampling interface 207. As the light interacts with the sample 240, at least a portion of the light will be returned to the sampling interface 207 (e.g., via scattering) at the set of ray positions, angles, and directions that define the first collected light beam 214a. The amount of light that returns to the optical measurement system 200 as the first collected light beam 214a depends at least in part on the sample characteristics (e.g., the scattering coefficient, the absorption coefficient, and the refractive index) of the sample, as well as the one or more properties being measured by the optical measurement system 200 (e.g., the presence and/or concentration of a particular substance within the sample). Additionally, the depolarization of the input light beam 212 depends at least in part on the sample characteristics. For example, light collected from a sample with a higher scattering coefficient may experience, on average, more scattering events as compared to light collected from a sample with a lower scattering coefficient. These additional scattering events may contribute to depolarization of light collected by the optical measurement system 200 for the detector elements 204a-204c.

While individual photons may take different paths through the sample 240, collectively the light that is collected for the first detector element 204a (i.e., the first collected light beam 214a) will predominantly travel through a particular volume of the sample 240. For example, FIG. 2A depicts a sampling volume 216 of possible optical paths for light that is collected for the first detector element 204a. Specifically, the sampling volume 216 represents the possible regions of the sample that may be measured by the first detector element 204a (i.e., by a photon in the input light beam 212 returning to the optical measurement system 200 as part of the first collected light beam 214a) with a minimum threshold probability. In other words, it may be possible for an individual photon measured by the first detector element 204a to travel outside of the sampling volume 216, but the likelihood of that happening is below the minimum threshold probability.

Individual photons may take a range of different possible optical paths in the measured sample 240, and each possible optical path has a corresponding likelihood of occurrence for a given photon. Collectively, photons may be more likely to follow optical paths having a given optical path length (or range of optical path lengths). For example, FIG. 2B shows a plot 230 of probability as a function of optical path length, which represents the relative probability that a photon of light, collected for a given detector element, has traversed a particular optical path length. Specifically, plot 230 includes a first path length distribution 232 of the first collected light beam 214a, as shown in FIG. 2A, that is collected for the first detector element 204a. The optical path distribution, the path length distribution, and the sampling depth distribution of a collected light beam for a given detector element are also referred to herein as the “collected optical path distribution,” the “collected path length distribution,” and the “collected sampling depth distribution,” respectively, for that detector element. Similarly, the optical path distribution, the path length distribution, and the sampling depth distribution of light that is incident on given detector element are also referred to herein as the “incident optical path distribution,” the “incident path length distribution,” and the “incident sampling depth distribution,” respectively, for that detector element.

The first path length distribution 232 has a first median path length 233. As used herein, a “median path length” of a path length distribution refers to the path length that represents the 50% value of a cumulative distribution function that is based on the path length distribution. In other words, a given photon of a beam of light (e.g., collected for or incident on a detector element) has a 50% probability of traveling an optical path length in the sample 240 that is shorter than the median path length.

The optical measurement system is also configured to collect additional light beams for the remaining detector elements of the array of detector elements 204a-204c. Accordingly, when the optical measurement system 200 is operated to emit the input light beam 212 into a sample 240, the optical measurement system 200 is configured to collect a plurality of collected light beams, such that each collected light beam is collected for a respective detector element of the array of detector elements 204a-204c. Each of the plurality of collected light beams has a different set of beam properties as it exits the sample 240 and thereby enters the optical measurement system 200 through the sampling interface 207. Accordingly, each collected light beam may be associated with a different optical path distribution (e.g., a different path length distribution and/or a different sampling depth distribution). For example, FIG. 2B shows a second path length distribution 234 that corresponds to a second collected light beam 214b (not shown in FIG. 2A) collected for the second detector element 204b and a third path length distribution 236 that corresponds to a third collected light beam 214c (not shown in FIG. 2A) collected for the third detector element 204c.

In the variation shown in FIGS. 2A and 2B, the optical measurement system 200 is configured to collect, for each of the first detector element 204a, second detector element 204b, and third detector element 204c, a corresponding collected light beam having a different median path length. Specifically, the second path length distribution 234 has a second median path length 235 that is longer than the first median path length 233, such that the light collected for the second detector element 204b has, on average, a longer optical path length than light collected for the first detector element 204a. The third path length distribution 236 has a third median path length 237 that is longer than the second median path length 235, such that the light collected for the third detector element 204c has, on average, a longer optical path length than light collected for the second detector element 204b.

Similarly, each of the collected light beams 214a-214c has a corresponding sampling depth distribution having a corresponding median sampling depth. As used herein, a “median sampling depth” of a sampling depth distribution refers to the sampling depth that represents the 50% value of a cumulative distribution function that is based on the sampling depth distribution. In other words, a given photon measured by a measurement channel has a 50% probability of reaching a sampling depth in the sample that is shorter than the median sampling depth. In some variations, the plurality of collected light beams 214a-214c have corresponding sampling depth distributions with a common median sampling depth. In other variations, some or all of the collected light beams 214a-214c have sampling depth distributions with different median sampling depths.

Depending on the configuration of the optical measurement system 200, the corresponding light beams collected for the array of detector elements 204a-204c may or may not overlap. For example, FIG. 2C and FIG. 2D show top views of different variations of the sampling interface 207 of the optical measurement system 200 of FIG. 2A. As shown, the launch site 208 is laterally spaced from the collection site 210 along a first dimension (e.g., along the X axis shown in FIGS. 2C and 2D). The optical measurement system 200 is configured to emit the input light beam 212 from the launch site 208, and is configured to collect the plurality of collected light beams (e.g., the first collected light beam 214a, the second collected light beam 214b, an the third collected light beam 214c) through the collection site 210. Accordingly, when the optical measurement system 200 is operated to emit the input light beam 212, a portion of this light is returned to optical measurement system 200 as part of each of the plurality of collected light beams 214a-214c. Each of the plurality of collected light beams 214a-214c, as they enter the optical measurement system 200, are laterally spaced from the launch site 208 (and the portion of the launch site through which the input light beam 212 exits the launch site 208) along the first dimension.

FIGS. 2C and 2D illustrate the beam size, beam shape, and beam location of the input light beam 212 as it exits the launch site 208, as well as the beam size, beam shape, and beam location of each of the plurality of collected light beams 214a-214c as it enters the collection site 210. In the variation shown in FIG. 2C, at least some of the plurality of collected light beams overlap along the first dimension as they enter the collection site 210. For example, the first collected light beam 214a at least partially overlaps the second collected light beam 214b. Additionally or alternatively, the second collected light beam 214b may at least partially overlap the third collected light beam 214c. Although the first collected light beam 214a and the third collected light beam 214c are positioned in FIG. 2C so as to not overlap as they enter the collection site 210, it should be appreciated that the optical measurement system 200 may be alternatively configured such that the first collected light beam 214a and the third collected light beam 214c at least partially overlap as they enter the collection site 210.

In these instances, light entering a given spatial location of the collection site 210 may be routed to different detector elements depending on the angle of incidence and/or direction of light reaching the sampling interface 207. For example, if light enters the collection site 210 at a location where the first collected light beam 214a and the second collected light beam 214b overlap, the light may be directed to first detector element 204a for photons entering the sampling interface 207 with a first angle of incidence (or first range of angles of incidence) and may be directed to the second detector element 204b for photons entering the sampling interface 207 with a second angle of incidence (or second range of angles of incidence). An arrangement in which certain collected light beams overlap along the first dimension, such as shown in FIG. 2C, may allow for more compact sensing arrangements, as well as more efficient light collection from a sample.

Conversely, in the variation shown in FIG. 2D, none of the plurality of collected light beams 214a-214c overlap along the first dimension as they enter the collection site 210. In these instances, the entire width of first collected light beam 214a (as it enters the collection site 210) along the first dimension is positioned between the second collected light beam 214b (as it enters the collection site 210) and the input light beam 212 (as it exits the launch site 208). Similarly, the entire width of second collected light beam 214b along the first dimension is positioned between the first collected light beam 214a and the third collected light beam 214c. An arrangement in which the collected light beams do not overlap along the first dimension as the enter the collection site 210, such as shown in FIG. 2D, may allow for collection of light from a wider spatial extent of a sample. Such an arrangement may also increase the differences in median sampling depth and/or median path length for light collected by the plurality of collected light beams.

In some variations, the input light beam 212 may be configured such that it has a beam width that is narrower, as the input light beam 212 exits the launch site 208, along the first dimension as compared to its beam width along a second dimension that is perpendicular to the first dimension (e.g., along the Y axis shown in FIGS. 2C and 2D). For example, in some variations, the input light beam 212 has a beam width in the second dimension that is at least four times larger than the beam width in the first dimension. In some of these variations, the beam width in the second dimension is at least eight times larger than the beam width in the first dimension. While the input light beam 212 is shown in FIGS. 2C and 2D as having a rectangular beam shape, it should be appreciated that input light beam 212 may have other shapes as may be desired. For example, the input light beam 212 may have a beam shape that is a rounded rectangle (e.g., a rectangle with rounded edges), an oval (e.g., an ellipse), or the like. In the instance of a non-rectangular beam shape, the beam width of a light beam in a particular dimension refers to the largest width of the light beam along that dimension.

For a given shape of the input light beam 212, there may be multiple locations on the collection site 210 such that, for a given combination of angle of incidence and direction, light entering the collection site 210 will have the same optical path distribution. For example, when the input light beam 212 has a rectangular shape as shown in FIGS. 2C and 2D, different locations on the collection site 210 that are positioned a common distance from the input light beam along the first dimension (e.g., locations that are positioned along a line parallel to the second dimension) may be associated with a common optical path distribution. Accordingly, in the variations of the optical measurement system 200 shown in FIGS. 2C and 2D, the selection of lengths of the input light beam 212 and the collected light beams 214a-214c may not impact the optical path distributions of the collected light beams 214a-214c.

While each of the collected light beams 214a-214c is shown in FIGS. 2C and 2D as having a rectangular beam shape, it should be appreciated that the optical measurement system 200 may be configured to collect, for various detector elements, light beams having non-rectangular beam shapes. Additionally or alternatively, some or all of the plurality of collected light beams may be configured to be narrower along the first dimension (e.g., along the X axis) than along the second dimension (e.g., along the Y axis). For example, in the variation shown in FIG. 2C, the first collected light beam 214a has a beam width in the second dimension that is larger than its beam width in the first dimension. In some of these variations, the beam width of the first collected light beam 214a in the second dimension that is at least four times larger than the beam width in the first dimension. In some of these variations, the beam width of the first collected light beam 214a in the second dimension is at least eight times larger than the beam width in the first dimension. It should be appreciated that each of the plurality of collected light beams 214a-214c may have the same aspect ratio (e.g., the ratio between the beam widths of the second and first dimensions), or different collected light beams may have different aspect ratios depending on the design of the optical measurement system 200.

FIG. 2E shows a top view of the optical measurement system 200 with the sampling interface 207 removed, in which the plurality of detector elements 204a-204c is spaced from the light beam generator 202 along the first dimension. As shown, each of the plurality of detector elements 204a-204c may have a rectangular shape with a corresponding width along the first dimension (e.g., along the X axis) and a length along the second dimension (e.g., along the Y axis). Specifically, the first detector element 204a has a first width w₁, the second detector element has a second width w₂, and the third detector element has a third width w₃. In the variation shown in FIG. 2E, the plurality of detector elements 204a-204c each have a common width along the first dimension (e.g., the first width w₁, the second width w₂, and the third width w₃ are all the same value). In some of these variations, each of the plurality of detector elements 204a-204c have a common length along the second dimension, though it should be appreciated that in other instances different detector elements may have different lengths along the second dimension.

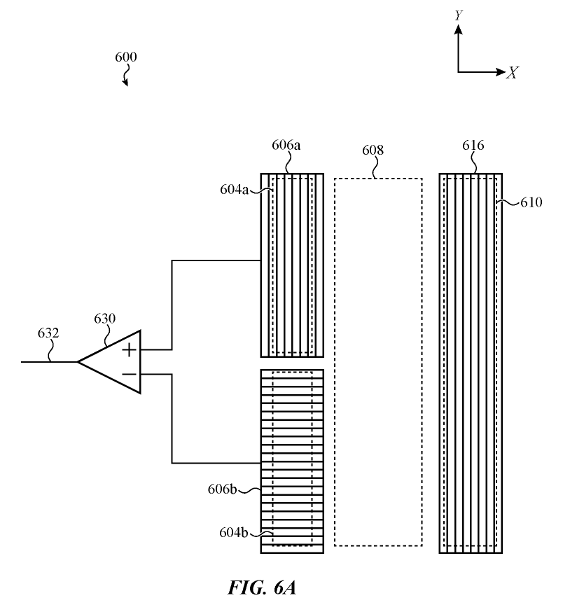

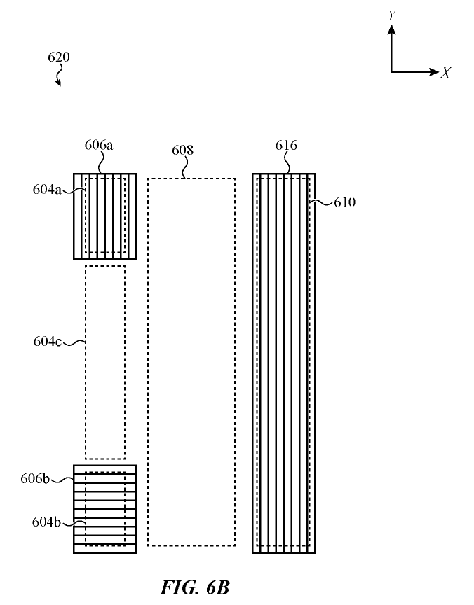

For example, in some variations one of the detector elements (e.g., the detector element 204a) may be replaced with a plurality of detector elements that are laterally spaced from each other along the second dimension. In these instances, the detector element is effectively split into multiple detector elements having a common collected optical path distribution, and these detector elements may have different lengths along the second dimension as compared to the lengths of other detector elements of the array. Examples of such an arrangement are described herein with respect to FIGS. 6A and 6B.

The dimensions of the plurality of detector elements 204a-204c may be proportional to the dimensions of the corresponding plurality of collected light beams 204a-204c, such that when the plurality of detector elements 204a-204c each have a common first width, the plurality of collected light beams 214a-214c may also each have a common second width (such as shown in FIGS. 2C and 2D). In other instances, some or all of the plurality of detector elements 204a-204c (and thereby the plurality of collected light beams 214a-214c) may have different widths along the first dimension. For example, FIG. 2F shows a top view of another variation of the optical measurement system 200 of FIG. 2E, except that the plurality of detector elements 204a-204c (and thus the plurality of collected light beams 214a-214b) have different widths along the first dimension.

For example, the first width w₁ of the first detector element 204a may be less than the second width w₂ of the second detector element 204b, and thus the beam width of the first collected light beam 214a may be less than the beam width of the second collected light beam 214b along the first dimension. Additionally or alternatively, the third width w₃ of the third detector element 204c may be less than second width w₂ of the second detector element 204b, and thus the beam width of the third collected light beam 214c may be less than the beam width of the second collected light beam 214b along the first dimension. In some of these variations, the first width w₁ and the third width w₃ are the same, and the first collected light beam 214a and the third collected light beam 214c have the same beam width along the first dimension. In others of these variations, such as shown in FIG. 2F, the first width w₁ is smaller than the third width w₃, such that the first collected light beam 214a has a narrower beam width along the first dimension as compared to the third collected light beam 214c.

It should be appreciated that the relative sizes of the plurality of detector elements 204a-204c and the corresponding plurality of collected light beams 214a-214c may be selected to adjust the relative optical path distributions of the plurality of collected light beams 214a-214c. This in turn may impact the signal-to-noise ratio (SNR) of light measured by the plurality of detector elements 204a-204c.

For example, as discussed with respect to FIG. 2B, the optical measurement system 200 may be configured such that the light collected for the first detector element 204a (e.g., the first collected light beam 214a) has a shorter first median path length 233 than the second median path length 235 of light collected for the second detector element 204b (e.g., the second collected light beam 214b). In volume-scattering samples, the intensity of light that exits the sample after scattering will generally decrease as a function of path length within the sample. Accordingly, although the variations of optical measurement system 200 shown in FIG. 2C and 2D are configured to collect a first collected light beam 214a and a second collected light beam 214b having the same cross-sectional area (as they enter the collection site 210), the first collected light beam 214a may have a higher intensity, due to its shorter median path length, than the second collected light beam 214b. Accordingly, light measured by the first detector element 204a may have a higher SNR than light measured by the second detector element 204b.

Accordingly, reducing the width of the first detector element 204a (and the corresponding beam width of first collected light beam 214a in the first dimension) relative to the width of the second detector element 204b (and the corresponding beam width of the second collected light beam 214b in the first dimension) may reduce the difference in the respective amounts of light collected for these detector elements. Conversely, reducing the width of the third detector element 204c (and the corresponding beam width of third collected light beam 214c in the first dimension) relative to the width of the second detector element 204b (and the corresponding beam width of the second collected light beam 214b in the first dimension) may increase the difference in the respective amounts of light collected for these detector elements. Overall, the relative sizes and positions of the plurality of collected light beams may be selected to balance the collected optical path distribution and the anticipated collection intensity (assuming a given intensity of the input light beam) of light collected for the detector elements 204a-204c.

In the variations of the optical measurement system 200 shown in FIGS. 2A-2F, the plurality of detector elements 204a-204b are positioned such that there is a direct relationship between i) a distance of a given detector element to the light beam generator 202 and ii) the median path length of light collected for that detector element. For example, the first detector element 204a, for which the optical measurement system collects light having the shortest median path length, is the closest of the plurality of detector elements 204a-204c to the light beam generator 202. Conversely, the third detector element 204c, for which the optical measurement system collects light having the shortest median path length, is the furthest of the plurality of detector elements 204a-204c from the light beam generator 202. In some variations, an optical measurement system may be configured such that, for a plurality of detector elements, there is an inverse relationship between the distance of a detector element to a light beam generator and the median path length of light collected for that detector element.

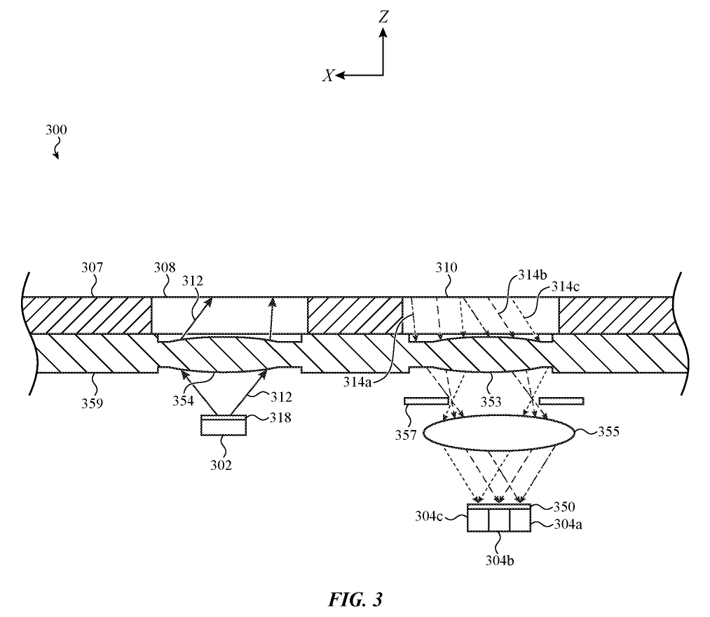

For example, FIG. 3 shows a cross-sectional side view of a variation of an optical measurement system 300 having such an inverse relationship. Specifically, the optical measurement system 300 includes a sampling interface 307 having a launch site 308 and a collection site 310, such as described in more detail herein. The optical measurement system 300 is configured to emit an input light beam 312 that is linearly polarized with a launch polarization as it exits the sampling interface 307. For example, the optical measurement system 300 may include a light beam generator 302 and a launch linear polarizer 318, such as described in more detail herein with respect to the optical measurement system 200 of FIGS. 2A-2F. In the variation shown in FIG. 3, the optical measurement system 300 may include a launch optical subassembly that includes one or more lens elements (shown in FIG. 3 as a single cylinder lens 354), positioned between launch linear polarizer 318 and the sampling interface 307. The launch optical subassembly may be configured to further shape and/or redirect the input light beam 312 after it has passed through the launch linear polarizer 318, but before it exits the sampling interface 307.

The optical measurement system 300 further includes a plurality of detector elements 304a-304c positioned in an array and is configured to collect a corresponding plurality of collected light beams 314a-314c for the plurality of detector elements 304a-304c. Each of the collected light beams 314a-314c enters the sampling interface 307 through the collection site 310, and is directed by the optical measurement system to a respective detector of the detector elements 304a-304c. For example, the array of detector elements 304a-304c is shown in FIG. 3 as including at least three detector elements: a first detector element 304a, a second detector element 304b, and a third detector element 304c. In these variations, the optical measurement system 300 is configured to collect at least a first collected light beam 314a that is collected for (and directed to) the first detector element 304a, a second collected light beam 314b that is collected for (and directed to) the second detector element 304b, and a third collected light beam 314c that is collected for (and directed to) by the third detector element 304c. The relative positions, sizes, and shapes of the plurality of collected light beams 314a-314c may be configured in any manner as described herein with respect to the collected light beams 214a-214c of FIGS. 2A-2F. For example, some or all of the collected light beams 314a-314b may overlap as they enter the collection site 310.

In the variation shown in FIG. 3, the plurality of detector elements 304a-304b are positioned such that there is an inverse relationship between i) a distance of a given detector element to the light beam generator 302 and ii) the median path length of light collected for that detector element. For example, the first collected light beam 314a is positioned closest, of the plurality of collected light beams 314a-314c, to the launch site 308 along a first dimension (e.g., along the X axis shown in FIG. 3), and thus the light collected for first detector element 304a has a first collected median path length that is the shortest of the three detector elements. The first detector element 304a, however, is positioned the furthest, of the plurality of detector elements 304a-304c, from the light beam generator 302 along the first dimension. Conversely, the third collected light beam 314c is positioned furthest from the launch site 308 along the first dimension, and thus the light collected for third detector element 304c (which is positioned closest to the light beam generator 302 along the first dimension) that has a third collected median path length that is the longest of the three detector elements. Light collected for the second detector element 304b may have a second collected median path length that is shorter than the third collected median path length and longer than the first collected median path length. Additionally, it should be appreciated that the plurality of collected light beams 314a-314c may have corresponding collected sampling depth distributions, and that these sampling depth distributions may have a common collected median sampling depth or different collected median sampling depths depending on the design of the optical measurement system 300.

The optical measurement system 300 may be configured in any suitable manner to provide the inverse relationship between detector element position and median collected path length. For example, in the variation shown in FIG. 3, the optical measurement system 300 may include a collection optical subassembly that includes an imaging lens 353 and a relay lens 355 separated by an aperture 357. In some variations, the imaging lens 353 and the relay lens 355 are each configured as cylinder lenses, which may allow for the profile of the collected light beams 314a-314c to be extended in a second dimension perpendicular to the first dimension. In some instances, one or more lenses of the launch optical subassembly may be formed as part of one or more common substrates with one or more lens of the collection optical subassembly. For example, in the variation shown in FIG. 3, the lens 354 of the launch optical subassembly and the imaging lens 353 of the collection optical subassembly are formed as part of a common substrate 359. For example, a first portion of the substrate 359 may be etched to define the lens 354 of the launch optical subassembly and a second portion of the substrate 359 may be etched to define the imaging lens 353 of the collection optical subassembly. Forming these lenses from different portions of a common substrate 359 may allow for precise relative positioning between these lenses within the optical measurement system 300.

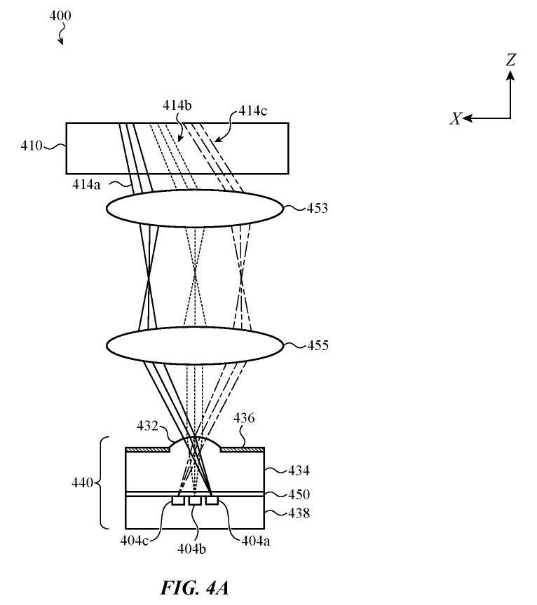

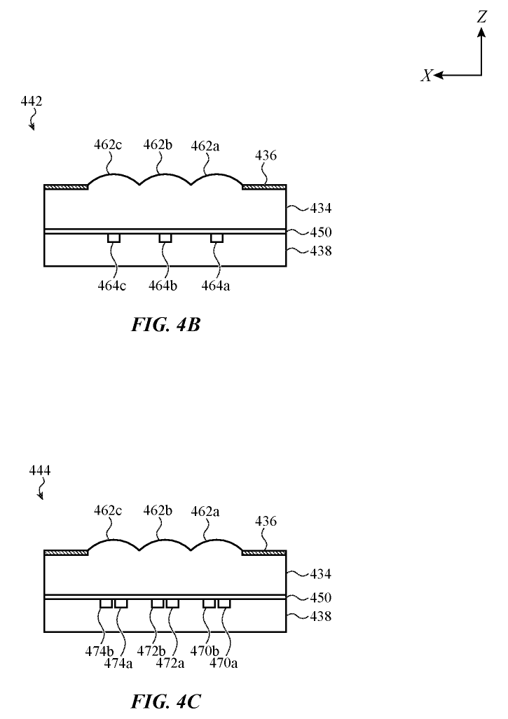

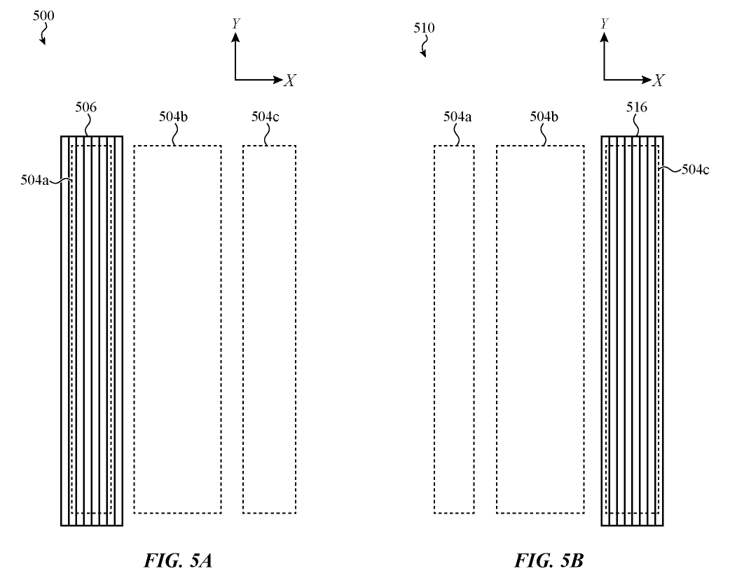

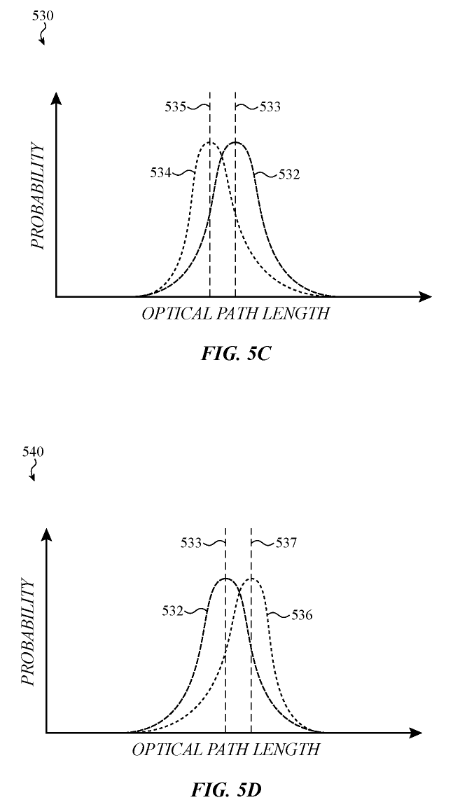

Also shown in FIG. 3 is a set of linear polarizers 350 that may be configured to polarize light collected by the optical measurement system 300. Specifically, the set of linear polarizers 350 may include one or more linear polarizers, each of which is configured to polarize at least some of the light collected for at least one of the array of detector elements 304a-304c. For example, different arrangements of the set of linear polarizers 350 are discussed herein with respect to FIGS. 5A-9C. The set of linear polarizers 350 may be incorporated into any portion of the optical measurement system 300 as desired to filter light collected by the optical measurement system 300. For example, linear polarizers of the set of linear polarizers 350 may be incorporated into a detector assembly that includes the detector elements 304a-304c (such as described herein with respect to FIGS. 4A-4C), between the detector assembly and the relay lens 355, or the like.

In some variations, the optical measurement systems described herein may include a collection optical subassembly that includes one or more condenser lenses. These condenser lenses may help to route one or more collected light beams to their corresponding detector elements. FIG. 4A depicts a cross-sectional side view of a collection optical subassembly of an optical measurement system 400 having an array of detector elements 404a-404c. Though not shown in FIG. 4A, the collection optical subassembly may be laterally spaced, along a first dimension (e.g., along the X axis shown in FIG. 4A), from the components used to generate an input light beam such as described in more detail with respect to FIGS. 2A-3. As shown in FIG. 4A, the collection optical subassembly includes a condenser lens 432.

In the variation shown in FIG. 4A, light collected by the optical measurement system 400 for each of the array of detector elements 404a-404c passes through the condenser lens 432 in order to reach the detector elements 404a-404c. Specifically, the optical measurement system 400 is configured to, when the optical measurement system 400 emits an input light beam into a measured sample, collect a plurality of collected light beams 414a-414c through a collection site 410 of a sampling interface as described in more detail herein. The optical measurement system 400 is further configured to direct each of the collected light beams 414a-414c to the condenser lens 432. For example, in the variation shown in FIG. 4A, the collection optical assembly of the optical measurement system 400 further includes a set of lenses (e.g., including an imaging lens 453 and relay lens 455) that is configured to collectively image the plurality of collected light beams 414a-414c onto the condenser lens 432. For example, the collection optical assembly 402 may be configured such that the condenser lens 432 is positioned at a focal plane of the set of lenses. In some of these variations, the optical measurement system 400 may include an aperture (not shown) positioned between the imaging lens 453 and the relay lens 455.

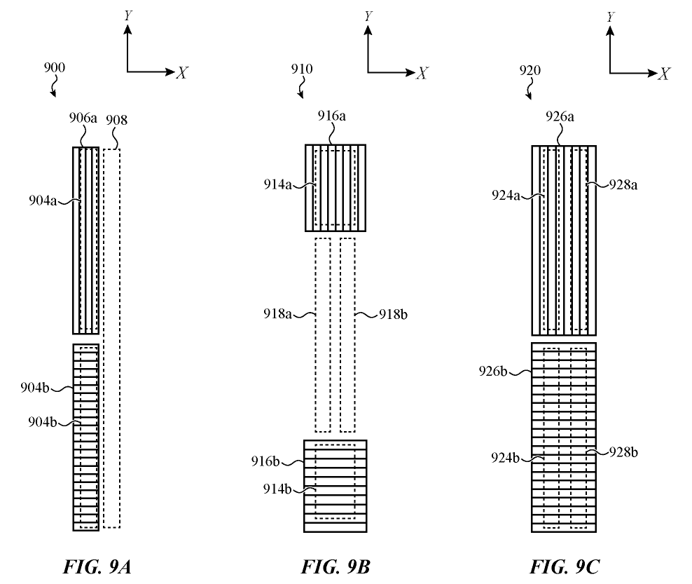

The condenser lens 432 is configured to direct each of the collected light beams 414a-414c to a corresponding detector element of the array of detector elements 404a-404c. Different detector elements within the array of detector elements 404a-404c may be associated with different collected optical path distributions and/or different collected path length distributions. For example, depending on the configuration of the optical measurement system 400, the plurality of collected light beams 414a-414c may have different collected path length distributions (e.g., some or all of the collected light beams 414a-414c have corresponding path length distributions with different median path lengths) and/or different collected sampling depth distributions (e.g., some or all of the collected light beams 414a-414c have corresponding sampling depth distributions with different median sampling depths). For example, in some variations, the plurality of collected light beams 414a-414c may have different collected sampling depth distributions but a common collected path length distribution. It should also be appreciated sets of detector elements within the array of detector elements may each be associated with a corresponding common collected optical path distribution, such as described herein with respect to FIGS. 9A-9C.

In some variations, the condenser lens 432 may be configured as an immersion condenser lens that is formed as part of a detector assembly 440. Specifically, the detector assembly 440 includes a substrate 434 and a layer stack 438 that is formed on or otherwise attached to the substrate 434. In these variations, the condenser lens 432 may be formed from a surface of the substrate 434, and the array of detector elements 404a-404c may be formed as part of a layer stack 438. For example, the layer stack 438 may include a set of epitaxial layers that are formed on substrate 434 and may collectively form the array of detector elements 404a-404c. In some instances, the layer stack 438 may include one or more absorber layers that are configured to absorb photons from incident light (and thereby generate electron-hole pairs), one or more buffer layers that are configured to reduce lattice mismatch between different layers of the layer stack 438, and/or one or more additional layers (e.g., passivation layers or the like). Examples of detector assemblies with immersion lenses are described in more detail in U.S. Patent Publication No. US2022/0037543A1, titled “Wideband Back-Illuminated Electromagnetic Radiation Detectors”, the contents of which are hereby incorporated by reference in their entirety. Additionally, in some variations the substrate 434 may further include an aperture layer 436 formed from a light-blocking material and at least partially surrounding the condenser lens 432. The aperture layer 436 may define an aperture of the condenser lens 432.

In the variation shown in FIG. 4A, the detector assembly 440 includes a polarizer layer 450 positioned between the substrate 434 and the array of detector elements 404a-404c. The polarizer layer 450 may include one or more linear polarizers of a set of linear polarizers, such as those described herein with respect to FIGS. 5A-9C. The linear polarizer(s) of the polarizer layer 450 may act to filter at least some of the light collected by the optical measurement system 400. The polarizer layer 450 is positioned between the condenser lens 432 and the array of detector elements 404a-404c, such that the linear polarizer(s) of the polarizer layer 450 may filter one or more of the collected light beams 414a-414c after the collected light beams 414a-414c have passed through the condenser lens 432 but before they are incident on their respective detector elements. It should be appreciated that portions of the polarizer layer 450 may not function as a linear polarizer, such that the polarization of light passing through these portions of the polarizer layer 450 is not altered.

While the detector assembly 440 is shown in FIG. 4A as having a single condenser lens 432, in other variations the optical measurement system 400 may include a detector assembly 440 that includes multiple condenser lenses. For example, FIG. 4B shows a variation of a detector assembly 442 that may be incorporated into the optical measurement system 400 of FIG. 4A (e.g., in place of or in addition to the detector assembly 440). The detector assembly 442 is configured and labeled the same as the detector assembly 440 of FIG. 4A, except that the single condenser lens 432 of the detector assembly 440 has been replaced by a plurality of condenser lenses 462a-462c (e.g., a first condenser lens 462a, a second condenser lens 462b, and a third condenser lens 462c) and the array of detector elements 404a-404c of the detector assembly 440 has been replaced by an array of detector elements 464a-464c that is formed as part of layer stack 438. The array of detector elements 464a-464c is positioned such that each detector element is positioned to receive light from a different corresponding condenser lens.

For example, the array of detector elements 464a-464c includes a first detector element 464a positioned to receive light from the first condenser lens 462a, a second detector element 464b positioned to receive light from the second condenser lens 462b, and a third detector element 464c positioned to receive light from the third condenser lens 462c. In this way, the optical measurement system may collect a first collected light beam (not shown) for the first detector element 464a, and this first collected light beam passes through the first condenser lens 462a and a first portion the polarizer layer before reaching the first detector element 464a. Similarly, a second collected light beam (collected for the second detector element 464b) passes through the second condenser lens 462b and a second portion of the polarizer layer 450 before reaching the second detector element 464b, and a third collected light beam (collected for the third detector element 464c) passes through the third condenser lens 462c and a third portion of the polarizer layer 450 before reaching the third detector element 464c. By positioning different detector elements under different condenser lenses, the optical measurement system 400 may have additional flexibility in setting the relative optical path distributions of light collected for the plurality of detector elements 464a-464c.

While the detector assembly 442 of FIG. 4B is configured such that each of the plurality of condenser lenses 462a-462c directs light to a single corresponding detector element, in other variations one or more of the condenser lenses 462a-462c may be configured to direct light to each of multiple detector elements. For example, FIG. 4C shows a variation of a detector assembly 444 that may be incorporated into the optical measurement system 400 of FIG. 4A (e.g., in place of or in addition to the detector assembly 440). The detector assembly 444 is configured and labeled the same as the detector assembly 442 of FIG. 4B, except that the array of detector elements 464a-464c of the detector assembly 440 has been replaced with an array of detector elements that includes multiple sets of detector elements, each of which corresponds to a different condenser lens of the plurality of condenser lenses 462a-462c. For example, a first set of detector elements 470a-470b (e.g., including a first detector element 470a and a second detector element 470b) is positioned to receive light from the first condenser lens 462a, a second set of detector elements 472a-472b (e.g., including a first detector element 472a and a second detector element 472b) is positioned to receive light from the second condenser lens 462b, and a third set of detector elements 474a-474b (e.g., including a first detector element 474a and a second detector element 474b) is positioned to receive light from the third condenser lens 462c. While each of the first set of detector elements 470a-470b, the second set of detector elements 472a-472b, and the third set of detector elements 474a-474b is shown in FIG. 4C as including two corresponding detector elements, it should be appreciated some or all of these sets may have more or fewer detector elements as may be desired.

The optical measurement systems described herein include a set of linear polarizers configured to filter at least some of the light that is collected for an array of detector elements. Specifically, the set of linear polarizers may alter the optical path distribution and intensity of light that is incident on a given detector element as compared to the optical path distribution and intensity of light that is collected for that detector element. For example, FIG. 5A shows a portion of a variation of an optical measurement system 500 as described herein. The optical measurement system 500 is configured to emit an input light beam (not shown) that is linearly polarized with a launch polarization as it exits the optical measurement system 500. While not shown in FIG. 5A, the optical measurement system 500 may include a light beam generator and a launch linear polarizer that operate to emit the input light beam from a launch site of a sampling interface, such as described in more detail with respect to the optical measurement system 200 of FIGS. 2A-2F.

The optical measurement system 500 includes an array that includes a plurality of detector elements 504a-504c, each of which is laterally spaced from the light beam generator (and thereby the input light beam) by a different corresponding distance along a first dimension (e.g., the X-axis shown in FIG. 5A). In the variation shown in FIG. 5A, the plurality of detector elements 504a-504c includes a first detector element 504a positioned a first distance from the light beam generator, a second detector element 504b positioned a second distance from the light beam generator, and a third detector element 504c positioned a third distance from the light beam generator. The optical measurement system 500 is configured to collect, for each of the plurality of detector elements 504a-504c, a collected light beam (not shown) that enters the optical measurement system 500 through a collection site (e.g., the collection site 210 of the sampling interface 207 of the optical measurement system 200 of FIGS. 2A-2F) and is directed toward the respective detector element.

In an example, the optical measurement system 500 is configured to collect, for the first detector element 504a, a first collected light beam having a corresponding path length distribution (e.g., a first collected path length distribution). Similarly, the optical measurement system 500 is configured to collect, for the second detector element 504b, a second collected light beam having a corresponding path length distribution (e.g., a second collected path length distribution), and is further configured to collect, for the third detector element 504c, a third collected light beam having a corresponding path length distribution (e.g., a third collected path length distribution). Light incident on the first detector element 504a, the second detector element 504b and the third detector element 504c will have respective first, second, and third incident path length distributions.

The optical measurement system 500 further includes a set of linear polarizers. Each linear polarizer is positioned to filter light that is collected for a corresponding detector element (or elements) of the detector elements 504a-504c. This will change the optical path distribution (e.g., the sampling depth distribution and/or the path length distribution) of light incident on certain detector elements, as compared to the corresponding collected optical path distributions for these detector elements. For example, in the variation shown in FIG. 5A, the set of linear polarizers includes a first linear polarizer 506 positioned to filter light that is collected for the first detector element 504a. Specifically, the first linear polarizer 506 is positioned within the optical measurement system such that a first collected light beam, collected for the first detector element 504a, will at least partially pass through the first linear polarizer 506 before reaching the first detector element 504a. The first linear polarizer 506 has a corresponding polarization direction, such that the portion of the first collected beam is linearly polarized as it passes through the first linear polarizer 506. In this way, at least a portion of the light incident on the first detector element 504a, by virtue of passing through the first linear polarizer 506, will be linearly polarized.

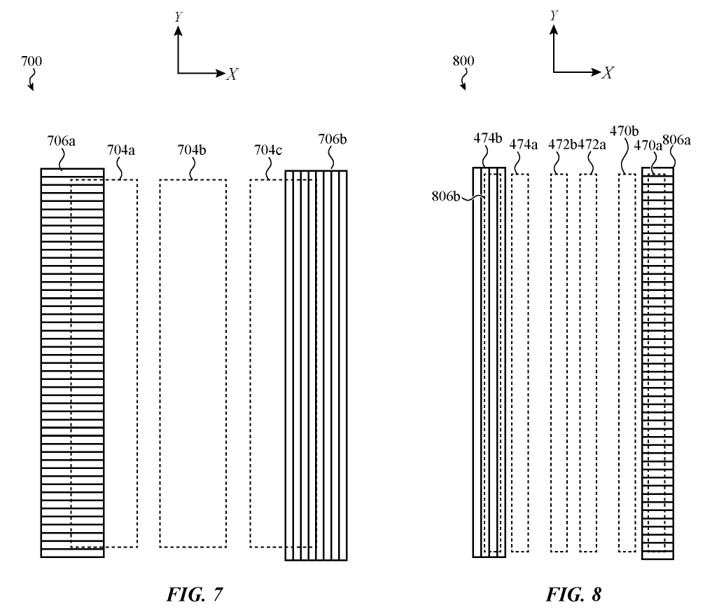

In the variation shown in FIG. 5A, the first linear polarizer 506 is sized and positioned such that entire first collected light beam passes through the first linear polarizer 506. In these instances, the entire collected light beam is filtered, and thus all of the light incident on the first detector element 504a will be linearly polarized. In other variations, such as described in more detail herein with respect to FIG. 7, the first linear polarizer 506 may be sized and positioned such that only a first portion of the first collected light beam passes through the first linear polarizer 506. A second portion of the first collected light beam may not pass through a linear polarizer (neither the first linear polarizer 506 nor any other linear polarizers of the set of linear polarizers) before reaching the first detector element 504a. In this way, a first subset of the light incident on the first detector element 504a (e.g., corresponding to the first portion of the first collected light beam) will be linearly polarized, and a second subset of the light incident on the first detector element 504a (e.g., corresponding to the second portion of the first collected light beam) will maintain its polarization as initially collected by the optical measurement system.

The polarization direction of the first linear polarizer 506 may at least partially control how the first linear polarizer 506 adjusts the path length distribution and/or the sampling depth distribution of the light incident on the first detector element 504a. For example, in some variations, when the input light beam is linearly polarized by a launch linear polarizer, the first linear polarizer 506 and the launch linear polarizer may be the same polarization direction. In these instances, the first linear polarizer 506 passes light having the launch polarization of the input light beam, and filters out light having the non-launch polarization. When the first linear polarizer 506 is configured to pass light having the launch polarization, the first linear polarizer 506 may act to both i) narrow the path length distribution of the first collected light beam as it passes through the first linear polarizer 506, and ii) decrease the median path length of the first collected light beam as it passes through the first linear polarizer 506.

FIG. 5C shows a plot 530 that includes the first collected path length distribution 532 of the first collected light beam as it enters the optical measurement system 500. The plot 530 further includes the first incident path length distribution 534, which represents the path length distribution of the first collected light beam after is passes through the first linear polarizer 506. In other words, the first collected path length distribution 532 represents light that is collected for the first detector element 504a, and the first incident path length distribution 534 represents light that is incident on and measured by the first detector element 504a. As shown, the first collected path length distribution 532 has a median path length 533 (also referred to herein as the “first collected median path length 533”) and the incident path length distribution first 534 has a median path length 535 (also referred to herein as the “first incident median path length 535”) that is shorter than the first collected median path length 533.

When a linearly polarized input light beam is introduced into a volume-scattering sample, scattering within the sample may cause the polarization state of individual photons to change. Accordingly, when the optical measurement system 500 collects light returned from the sample, the collected light may be at least partially depolarized and may include a mix of light having two orthogonal polarization states (e.g., the launch polarization and the non-launch polarization). The amount of depolarization depends on the number of scattering events, which in turn depends on both i) the scattering coefficient of the sample, and ii) the path length of the light within the sample. Light traveling through samples with relatively lower scattering coefficients will typically undergo less scattering, and thus light collected from these samples will have a higher proportion of light having the launch polarization as compared to light collected from samples with relatively higher scattering coefficients. Additionally, within the path length distribution of light collected by an optical measurement system (e.g., collected for a given detector element thereof), longer path lengths are associated with more scattering events and thus are more likely to be depolarized.

Accordingly, when the first linear polarizer 506 filters out light having the non-launch polarization, the filtered light is more likely to be associated with longer path lengths. This results in the path length distribution of light incident on the first detector element 504a (e.g., the first incident path length distribution 534 of FIG. 5C) being skewed toward shorter path lengths as compared to the path length distribution of light collected for the first detector element 504a (e.g., the first collected path length distribution 532 of FIG. 5C). This may act to narrow the first incident path length distribution 534 as compared to the first collected path length distribution 532, which may thereby improve the accuracy of measurements performed using the first detector element 504a. Additionally, the median path length of light incident on the first detector element 504a (e.g., the first incident median path length 535) will be shorter than the median path length of light collected for the first detector element 504a (e.g., the first collected median path length 533).

Conversely, in variations where the first linear polarizer 506 has a polarization direction orthogonal to the launch linear polarizer, the first linear polarizer 506 will filter out light having the launch polarization and pass light having the non-launch polarization. In these instances, the first linear polarizer 506 will act to skew the first collected path length distribution 532 toward longer path lengths. FIG. 5D shows a plot 540 that includes the first collected path length distribution 532, and further includes a variation of the first incident path length distribution (labeled instead as “first incident path length distribution 536”) in variations where the first linear polarizer 506 has a polarization direction orthogonal to the launch linear polarizer. In these instances the first collected path length distribution 536 has a median path length (referred to herein as the “first incident median path length 537”) that is longer than the first collected median path length 533. It should also be appreciated that, by selectively filtering out light associated with longer path lengths (in the instance of FIG. 5C) or shorter path lengths (in the instance of FIG. 5D), the first linear polarizer 506 may also act to change one or more aspects of the sampling depth distribution of light incident the first detector element 504a as compared to light collected for the first detector element 504a.

It should be appreciated that when two polarizers are discussed herein as having orthogonal polarization directions or having the same polarization direction, some misalignment between these polarizers may be tolerated. Accordingly, two polarizers with polarization directions that are within 15 degrees of being orthogonal (e.g., are separated by an angle of at least 75 degrees) are considered to have orthogonal polarization directions. Similarly, two polarizers with polarization directions that are within 15 degrees of being parallel (e.g., are separated by an angle that is less than 15 degrees) are considered to have the same polarization direction.

Accordingly, each linear polarizer of the set of linear polarizers may be selected to alter the incident optical path distributions for one or more detector elements relative to the collected optical path distributions for these detector elements. For example, the optical measurement system 500 may be configured to collect, for each of the plurality of detector elements 504a-504c, a corresponding collected light beam having a different median path length. Specifically, the first collected median path length 533 of the first collected light beam may be shorter than a median path length of the second collected light beam (e.g., a second collected median path length). Similarly, the second collected median path length may be shorter than a median path length of the third collected light beam (e.g., a third collected median path length). For example, in some instances, the first detector element 504a, the second detector element 504b, and the third detector element 504c corresponds to the first detector element 204a, the second detector element 204b, and the third detector element 204c, respectively, of the optical measurement system 200 of FIGS. 2A-2F. In other instances, the first detector element 504a, the second detector element 504b, and the third detector element 504c corresponds to the first detector element 304a, the second detector element 304b, and the third detector element 304c, respectively, of the optical measurement system 300 of FIG. 3. In still other instances, the plurality of detector elements 504a-504c correspond to different detector elements of one of the detector assemblies of FIGS. 4A-4C.

In the variation shown in FIG. 5A, the optical measurement system 500 includes a set of linear polarizers that includes the first linear polarizer 506, where the first linear polarizer 506 is positioned to filter at least a portion of the first collected light beam that is collected for the first detector element 504a. Accordingly, the first linear polarizer 506 changes the first incident optical path distribution relative to the first collected optical path distribution for the first detector element 504a. In some of these variations, the first linear polarizer 506 changes the first incident path length distribution (e.g., the first incident path length distribution 534 or the first incident path length distribution 536 described herein with respect to FIGS. 5C and 5D, respectively) relative to the first collected path length distribution (e.g., the first collected path length distribution 532 described herein with respect to FIGS. 5C and 5D) for the first detector element 504a.

In the variation shown in FIG. 5A, at least one of the plurality of detector elements 504a-504c is not filtered by the set of linear polarizers, such that the corresponding collected optical path distribution for each detector element of these detector elements is the same as the incident optical path distribution for that detector element. Specifically, in the variation shown in FIG. 5A, the set of linear polarizers does not filter the corresponding light beams collected for each of the second detector element 504b and the third detector element 504c. Specifically, a second incident optical path distribution (e.g., of light that is incident on the second detector element 504b) is the same as a second collected optical path distribution (e.g., of light that is collected for the second detector element 504b). Similarly, a third incident optical path distribution (e.g., of light that is incident on the third detector element 504c) is the same as a third collected optical path distribution (e.g., of light that is collected for the third detector element 504c).

In variations where the first linear polarizer 506 filters out light having the non-launch polarization, such as described with respect to FIG. 5C, the first detector element 504a may measure light having a narrower path length distribution as compared to light collected for the first detector element 504a. In these instances, the optical measurement system 500 may sacrifice some collection efficiency for the first detector element 504a (e.g., by filtering out some of the first collected light beam) for increased accuracy that may result from measuring light with a narrower path length distribution. Conversely, the optical measurement system 500 may prioritize collection efficiency for the second detector element 504b and third detector element 504c by not filtering the respective second and third collected light beams with the set of linear polarizers. In these instances, the presence of the first linear polarizer 506 may increase a difference between the median path lengths of light incident on the first detector element 504a (e.g., the first incident median path length) and light incident on the second detector element 504b (e.g., the second incident median path length).

In other variations, such as when the first linear polarizer 506 is configured to filter out light having the launch polarization, the presence of the first linear polarizer 506 may decrease a difference between the median path length of light incident on the first detector element 504a (e.g., the first incident median path length) and the median path length of light incident on the second detector element 504b (e.g., the second incident median path length). This may, however, further reduce the collection efficiency of the first detector element 504a as compared to variations in which the first linear polarizer 506 is configured to filter out light having the non-launch polarization. Overall, by selecting the polarization direction of the first linear polarizer 506, the optical measurement system 500 may be configured to alter the first incident path length distribution for a given first detector element 504a.

FIG. 5B shows another variation of an optical measurement system 510, which may be configured the same as the optical measurement system 500 of FIG. 5A except that the set of linear polarizers includes a second linear polarizer 516 that is positioned to filter light that is collected for the third detector element 504c. Specifically, the second linear polarizer 516 is positioned within the optical measurement system such that the third collected light beam, which is collected for the third detector element 504c, will at least partially pass through the second linear polarizer 516 before reaching the third detector element 504c. The second linear polarizer 516 has a corresponding polarization direction, such that the portion of the first collected beam is linearly polarized as it passes through the second linear polarizer 516. In this way, at least a portion of the light incident on the third detector element 504c, by virtue of passing through the second linear polarizer 516, will be linearly polarized.

In some variations, the polarization direction of the second linear polarizer 516 is the same as the polarization direction of the launch linear polarizer, such that the second linear polarizer 516 is configured to filter out light having the non-launch polarization from at least a portion of the third collected light beam. In these variations, the path length distribution of light incident on the third detector element 504c (e.g., the third incident path length distribution) will have a median path length (referred to herein as the “third incident median path length”) that is shorter than a median path length of the third collected path length distribution (referred to herein as the “third collected median path length”). In these instances, in addition to providing a narrower third incident path length distribution (as compared to the third collected path length distribution), the second linear polarizer 516 may act to decrease a difference between the third median path length and the median path length of light incident on the second detector element 504b (e.g., the second incident median path length). In other variations, the second linear polarizer 516 may instead be configured to filter out light having the launch polarization, such as described with respect to FIG. 5D.

In some variations, the optical measurement system 510 may be configured such that the set of linear polarizers does not filter the corresponding light beams collected for each of the first detector element 504a and the second detector element 504b. In these variations, the first incident optical path distribution is the same as the first collected optical path distribution for the first detector element 504a, and the second incident optical path distribution is the same as the second collected optical path distribution for the second detector element 504b. In other variations, the optical measurement system 510 may be configured to include the second linear polarizer 516 in addition to the first linear polarizer 506 of the optical measurement system 500 of FIG. 5A. In some of these variations, the first linear polarizer 506 and the second linear polarizer 516 have the same polarization direction (e.g., are both configured to filter light having the launch polarization or are both configured to filter light having the non-launch polarization). In other variations, the first linear polarizer 506 and the second linear polarizer 516 have orthogonal polarization directions, such that one of the linear polarizers filters light having the launch polarization and the other of the linear polarizers filters light having the non-launch polarization. An example of such arrangement is described herein with respect to FIG. 7.

In some instances, it may be desirable for the optical measurement systems described herein to be able to measure or otherwise control for the scattering coefficient of the sample being measured. Depending on the type of sample being measured, the optical measurement system may encounter different individual samples having a range of different scattering coefficients. For example, the optical measurement system may be configured to measure a type of sample that may vary in scattering coefficient by a factor of two, three, or more between different samples. These differences in scattering coefficient between different samples may change how light is returned to the optical measurement system, which may in turn impact the accuracy of measurements performed the optical measurement system if not otherwise accounted for.

Accordingly, in some variations the optical measurement system may generate, using at least a pair of detector elements, one or more measurement signals that may be used to measure or otherwise control for the scattering coefficient of the sample. For example, FIG. 6A shows a portion of a variation of an optical measurement system 600 as described herein. The optical measurement system 600 is configured emit an input light beam (not shown) that is linearly polarized with a launch polarization direction as it exits the optical measurement system 600. While not shown in FIG. 6A, the optical measurement system 600 may include a light beam generator and a launch linear polarizer that operate to emit the input light beam from a launch site of a sampling interface, such as described in more detail with respect to the optical measurement system 200 of FIGS. 2A-2F.

The optical measurement system 600 includes an array of detector elements that includes a plurality of sets of detector elements. Each set of detector elements includes at one or more detector elements associated with a common corresponding collected optical path distribution. Specifically, the optical measurement system 600 is configured to collect, for each detector element of a set of detector elements, a corresponding collected light beam having a common collected optical path distribution. Accordingly, the collected light beams collected for each of a given set of detector elements may have a common sampling depth distribution and a common path length distribution.

In the variation shown in FIG. 6A, the array of detector elements includes a first set of detector elements 604a-604b, a second set of detector elements 608, and a third set of detector elements 610. The optical measurement system 600 is configured to collect, for the first set of detector elements 604a-604b, a corresponding first set of collected light beams. Specifically, in the variation shown in FIG. 6A, the first set of detector elements 604a-604b includes a plurality of detector elements that includes at least a first detector element 604a and a second detector element 604b. Accordingly, the first set of collected light beams includes at least a first collected light beam that is collected for the first detector element 604a and a second collected light beam that is collected for the second detector element 604b. Each of these collected light beams may have a common first path length distribution and a common first sampling depth distribution. For example, the first detector element 604a and the second detector element 604b may each be laterally spaced away from the light beam generator along a first dimension (e.g., the X-axis shown in FIG. 6A) by a common first distance, and may be laterally spaced from each other along a second dimension perpendicular to the first dimension (e.g., the Y-axis shown in FIG. 6A). The first detector element 604a and the second detector element 604b may each have a common width along the first dimension.

In some of these variations, the first detector element 604a and the second detector element 604b may each have a common length along the second dimension, such that the first detector element 604a and the second detector element 604b each have a common detector area. In other variations, the first detector element 604a may have a different first length along the second dimension than a corresponding second length second of the second detector element 604b along the second dimension, such that the first detector element 604a and the second detector element 604b have different detector areas. The sample analysis techniques utilized by the optical measurement system 600 may account for differences in detector area between the first detector element 604a and the second detector element 604b when analyzing a measured sample.

The optical measurement system 600 is configured to collect, for the second set of detector elements 608, a corresponding second set of collected light beams. Each of these collected light beams may have a common second path length distribution (which may be different from the common first path length distribution) and a common second sampling depth distribution (which may be different from the common first sampling depth distribution). For example, each of the second set of detector elements 608 may be laterally spaced from the light beam generator along the first dimension by a common second distance that is different than the common first distance. In the variation shown in FIG. 6A, the second set of detector elements 608 includes a single detector element 608 (for which a single collected light beam having the common second path length distribution is collected), though it should be appreciated that in other instances the second set of detector elements 608 may include multiple detector elements that are laterally separated from each other along the second dimension.

Similarly, the optical measurement system 600 is configured to collect, for the third set of detector elements 610, a corresponding third set of collected light beams. Each of these collected light beams may have a third common path length distribution (which may be different from the common first and/or second path length distributions) and a third common sampling depth distribution (which may be different from the common first and/or second sampling depth distributions). For example, each of the third set of detector elements 610 may be laterally spaced from the light beam generator along the first dimension by a third common distance that is different than each of the first and second common distances. In the variation shown in FIG. 6A, the third set of detector elements 610 includes a single detector element 610 (for which a single collected light beam having the third common path length distribution is collected), though it should be appreciated that in other instances the third set of detector elements 610 may include multiple detector elements that are laterally separated from each other along the second dimension. The detector elements of the optical measurement system 600 may be used in place of the detector elements of the various optical measurement systems described herein with respect to FIGS. 2A-5D.

The optical measurement system 600 further includes a set of linear polarizers that includes at least a first plurality of linear polarizers 606a-606b. Each of the first plurality of linear polarizers 606a-606b is positioned to filter a corresponding collected light beam of the first set of collected light beams. Specifically, the first plurality of linear polarizers 606a-606b includes a first linear polarizer 606a and a second linear polarizer 606b. The first linear polarizer 606a is positioned to filter the first collected light beam that is collected for the first detector element 604a of the first set of detector elements 604a-604b. Similarly, the second linear polarizer 606b is positioned to filter the second collected light beam that is collected for the second detector element 604b of the first set of detector elements 604a-604b. The first linear polarizer 606a and the second linear polarizer 606b have orthogonal polarizations, such that the first linear polarizer 606a filters out light having the non-launch polarization and the second linear polarizer 606b filters out light having the launch polarization. In this way, the first detector element 604a may measure light having the launch polarization (e.g., with light of the non-launch polarization removed by the first linear polarizer 606a) and the second detector element 604b may measure light having the non-launch polarization (e.g., with light of the launch polarization removed by the second linear polarizer 606b).

Because the first detector element 604a and the second detector element 604b are associated with collected light beams having the common first optical path distribution, differences between the measurement signals generated by the first detector element 604a and the second detector element 604b may be representative of the scattering coefficient of the sample being measured. For example, measurements of samples having relatively lower scattering coefficients will result in a larger proportion of light measured by the first detector element 604a as compared to light measured by the second detector element 604b. Conversely, measurements of samples having relatively higher scattering coefficients will result in a smaller proportion of light measured by the first detector element 604a as compared to light measured by the second detector element 604b. Accordingly, the measurement signals generated by the first detector element 604a and the second detector element 604b may collectively be used to account for the scattering coefficient of a sample being measured by the optical measurement system 600.

In some variations, a controller of the optical measurement system 600 may receive separate measurement signals from each of the first detector element 604a and the second detector element 604b. This allows the measurement signals generated by these detector elements to be used individually by the controller in performing sample analysis. In other variations, the measurement signals generated by the first detector element 604a and a second detector element 604b may be electrically combined into a first combined measurement signal. For example, in the variation shown in FIG. 6A, the optical measurement system 600 may include an operation amplifier 630. The optical measurement system 600 is configured such that the operational amplifier 630 receives a first measurement signal from the first detector element 604a at a first input of the operational amplifier 630 and receives a second measurement signal from the second detector element 604b at a second input of the operational amplifier 630. The operational amplifier 630 outputs a first combined measurement signal 632, which represents a difference between the first measurement signal and the second measurement signal. A controller of the optical measurement system 600 may receive the first combined measurement signal 632, and the magnitude of this first combined measurement signal 632 may be indicative of the scattering coefficient of the sample currently being measured. In this way, the first combined measurement signal 632 may be used (e.g., by the controller or another processor performing the signal analysis) to control for a sample’s scattering coefficient during signal analysis. For example, the first combined measurement signal 632 may be used as an input of a regression model used to derive one or more properties of the sample. Additionally or alternatively, the first combined measurement signal 632 may be used to select a regression model (e.g., from a plurality of candidate regression models) that is used to derive one or more properties of the sample.

It should be appreciated that the set of linear polarizers may include additional linear polarizers beyond the first plurality of linear polarizers 606a-606b. For example, in the variation shown in FIG. 6A the set of linear polarizers further includes a third linear polarizer 616 that is positioned to filter light that is collected for some or all of the detector elements of the third set of detector elements 610. For example, in variations in which the third set of detector elements 610 includes a single detector element 610, the third linear polarizer 616 may positioned within the optical measurement system such that a collected light beam, which is collected for the detector element 610, will at least partially pass through the third linear polarizer 616 before reaching the detector elements 610. The third linear polarizer 616 may operate to change the incident optical path distribution for the detector element 610, such as described in more detail with respect to the second linear polarizer 516 of the optical measurement system 510 of FIG. 5B. In the variation shown in FIG. 6A, the third linear polarizer 616 is configured to filter out light having the non-launch polarization. In other variations, however, the third linear polarizer 616 may instead be configured to filter out light having the launch polarization. Some or all of the second set of detector elements 608 may not be filtered by the set of linear polarizers, such that the optical path distribution of light collected for each of these detector elements is the same as the optical path distribution of light that is incident on that detector elements.

In some variations, the first set of detector elements 604a-604b includes one or more additional detector elements that are not filtered by the set of linear polarizers. For example, FIG. 6B shows a variation of an optical measurement system 620 that may be configured the same as the optical measurement system 600 of FIG. 6A except that the first set of detector elements includes at least three detector elements. Specifically, the first set of detector elements includes the first detector element 604a, the second detector element 604b, and a third detector element 604c, and the first set of collected light beams includes a third collected light beam that is collected for the third detector element 604c. The third detector element 604c may generate a third measurement signal that may be used by the optical measurement system 620 in analyzing a sample. Accordingly, even though each of the first set of collected light beams has the same collected optical path distribution, the measurement signals generated by the different detector elements (or combined measurement signals generated therefrom) may provide different information about the sample being measured.

In some of these variations, the third detector element 604c may not be filtered by the set of linear polarizers, such that the optical path distribution of light collected for the third detector element 604c is the same as the optical path distribution of light that is incident on the third detector element 604c. In other variations, third detector element 604c may be filtered by a linear polarizer of the set of linear polarizers. For example, in variations in which the measurement signals of the first detector element 604a and the second detector element 604b are electrically combined to generate a combined measurement signal (e.g., using the operational amplifier of 630 of FIG. 6A), the third measurement signal may be representative of light that has an incident optical path distribution that is different than the collected optical path distribution for the third detector element 604c, such as described herein with respect to FIGS. 5A-5D. At least a portion of the third collected light beam, collected for the third detector element 604, may pass through a linear polarizer (e.g., a portion of the first linear polarizer 606a or an additional linear polarizer) that is configured to filter out light having the non-launch polarization. Alternatively, at least a portion of the third collected light beam may pass through a linear polarizer (e.g., a portion of the second linear polarizer 606b or an additional linear polarizer) that is configured to filter out light having the launch polarization.

The third detector element 604c is shown in FIG. 6B as positioned between the first detector element 604a and the second detector element 604b along the second dimension, though it should be appreciated that the first set of detector elements 604a-604c may be arranged in any suitable order. For example, the first detector element 604a may instead be positioned between the second detector element 604b and the third detector element 604c, or the second detector element 604b may be positioned between the first detector element 604a and the third detector element 604c. Additionally, the detector elements of the first set of detector elements 604a-604c may have any suitable relative sizes. For example, in the variation shown in FIG. 6B, each of the first set of detector elements 604a-604c have a common width along the first dimension, but the third detector element 604c has a longer length along the second dimension as compared to the respective lengths of each of the first detector element 604a and the second detector element 604b along the second dimension. In these instances, the third detector element 604c may have a larger detector area than the corresponding detector areas of each of the first detector element 604a and the second detector element 604b, which may prioritize the collection efficiency and SNR of the third detector element 604c. The first detector element 604a and the second detector element 604b may each have a common detector area or may have different detector areas as may be desired.

In the optical measurement systems described herein, different portions of a given detector element may be associated with different optical path distributions (e.g., different path length distributions and/or sampling depth distributions). For example, in the variation of the optical measurement system 200 shown in FIGS. 2A-2F, a first portion of the first detector element 204a that is positioned closer to the light beam generator 202 may be positioned to receive collected light that is associated with shorter path lengths as compared to collected light directed toward a second portion of the first detector element 204a that is positioned further away from the light beam generator 202. By selectively adjusting the light that is incident on different portions of a detector element, the optical measurement systems described herein may be able to further control the optical path distribution of light that is measured by that detector element.

Accordingly, in some variations of the optical measurement systems described herein, a linear polarizer may be positioned to filter only a portion of a collected light beam (e.g., less than the entire collected beam) that is collected for a given detector element. FIG. 7 shows one such variation of an optical measurement system 700. The optical measurement system 700 is configured emit an input light beam (not shown) that is linearly polarized with a launch polarization direction as it exits the optical measurement system 700. While not shown in FIG. 7, the optical measurement system 700 may include a light beam generator and a launch linear polarizer that operate to emit the input light beam from a launch site of a sampling interface, such as described in more detail with respect to the optical measurement system 200 of FIGS. 2A-2F.

The optical measurement system 700 includes an array of detector elements 704a-704c, each of which is laterally spaced from the light beam generator (and thereby the input light beam) by a different corresponding distance along a first dimension (e.g., the X-axis shown in FIG. 7). In the variation shown in FIG. 7, the array of detector elements 704a-704c includes a first detector element 704a positioned a first distance from the light beam generator, a second detector element 704b positioned a second distance from the light beam generator, and a third detector element 704c positioned a third distance from the light beam generator. The optical measurement system 700 is configured to collect, for each of the array of detector elements 704a-704c, a collected light beam (not shown) that enters the optical measurement system 500 through a collection site (e.g., collection site 210 of the optical measurement system 200 described herein with respect to FIGS. 2A-2F) and is directed toward the respective detector element.

In the variation shown in FIG. 7, the set of linear polarizers includes a first linear polarizer 706a positioned to filter a portion of a collected light beam (e.g., less than the entire collected light beam) that is collected for a detector element of the array of detector elements 704a-704c. While the first linear polarizer 706a is depicted in FIG. 7 as filtering a portion of a first collected light beam that is collected for the first detector element 704a, it should be appreciated that this linear polarizer may filter a portion of any collected light beam described herein, such as those described with respect to the optical measurement systems of FIGS. 2A-6B and 8-9C. As shown, the first linear polarizer 706a may be positioned within the optical measurement system such that a first portion of the first collected light beam passes through the first linear polarizer 706a and a second portion of the first collected light beam does not pass through the first linear polarizer 706a. As a result, a first subset of the light incident on the first detector element 704a (e.g., corresponding to the first portion of the first collected light beam) will be linearly polarized, and a second subset of the light incident on the first detector element 704a (e.g., corresponding to the second portion of the first collected light beam) will maintain its polarization as initially collected by the optical measurement system 700.

In some variations, the first linear polarizer 706a is positioned such that the first portion of the first collected light beam has a shorter median collected path length than a median collected path length of the second portion of the first collected light beam, and the first linear polarizer 706a is configured to filter out light that has the launch polarization. In these instances, the first linear polarizer 706a may act to increase the median path length of the first portion of the first collected light beam. This may allow for the first detector element 704a to be wider along the first dimension, and thereby collect more light without significantly altering the path length distribution of light incident on the first detector element 704a. Increasing the width of the first detector element 704a may both i) increase the width of the collected path length distribution for the first collected light beam, and ii) change the median path length of the collected path length distribution for the first collected light beam. The configuration of the first linear polarizer 706a allows the first detector element 704a to be expanded in a direction that captures additional light having, on average, shorter path lengths, but the first linear polarizer 706a will act to filter out light associated with the shorter path lengths. Because the second portion of the first collected light beam is not filtered by the set of linear polarizers, the incident optical path distribution is the same as the collected optical path distribution for the portion of the first detector element 704a that receives the second portion of the first collected light beam. In these instances, the second portion of the first collected light beam may prioritize collection efficiency.

Additionally or alternatively, a detector element may be configured to receive a collected light beam having a first portion having a relatively longer median path length and a second portion having a relatively shorter median path length, and a linear polarizer may be positioned to filter the first portion of a collected light beam. For example, in the variation shown in FIG. 7, the set of linear polarizers also includes a second linear polarizer 706b that is positioned to filter a portion of a third collected light beam that is collected for the third detector element 704c. In these variations, the second linear polarizer 706b is positioned such that a first portion of the third collected light beam passes through the second linear polarizer 706b and a second portion of the third collected light beam does not pass through the second linear polarizer 706b. The first portion of the third collected light beam has a longer median collected path length than a median collected path length of the second portion of the third collected light beam, and the second linear polarizer 706b is configured to filter out light that has the non-launch polarization. In this way, the third detector element 704c may be configured (e.g., widened along the first dimension) to collect additional light having, on average, longer path lengths. The second linear polarizer 706b may filter out light associated with longer path lengths, thereby allowing the third detector element 704c to measure more light without significantly impacting the overall incident optical path distribution for the third detector element 704c.

In some variations where the set of linear polarizers includes both the first linear polarizer 706a and the second linear polarizer 706b, the first collected light beam may have a median path length that is shorter than a median path length of the third collected light beam. In these instances, there may a first difference between the median path length of light collected for the first detector element 704a and the median path length of light collected for the third detector element 706c, and a smaller second difference between the median path length of light incident on the first detector element 704a and the median path length of light incident on the third detector element 706c. While the array of detectors shown in FIG. 7 includes a second detector element 704b positioned between the first detector element 704a and the third detector element 704c along the first dimension, in other variations the first detector element 704a and the third detector element 704c may not have an intervening detector element positioned between the first detector element 704a and the third detector element 704c. In some variations in which the array of detector elements 704a-704c does include the second detector element 704b positioned between the first detector element 704a and the third detector element 704c, the second detector element 704b may not be filtered by the set of linear polarizers. In these instances, the optical path distribution of light collected for the second detector element 704b is the same as the optical path distribution of light that is incident on the second detector element 704b.

In variations where multiple detector elements are positioned to receive light from a single condenser lens, such as discussed herein with respect to FIGS. 4A-4C, an optical measurement system may include a set of polarizers that is configured to provide different filtering to different detector elements associated with a single condenser lens. For example, FIG. 8 shows a variation of an optical measurement system 800 that may be configured in any manner as discussed herein with respect to the optical measurement system 400 of FIG. 4A and includes a detector assembly that is configured and labeled the same as the detector assembly 444 of FIG. 4C. The optical measurement system 800 includes a set of polarizers 806a-806b that may be used to filter collected light beams for the array of detectors. In the variation shown in FIG. 8, the set of polarizers 806a-806b includes a first linear polarizer 806a that is positioned to filter at least a portion of a collected light beam that is collected for the first detector element 470a of the first set of detector elements 470a-470b. In these variations, the optical measurement system 800 is configured to collect a first set of collected light beams for the first set of detector elements 470a-470b, and the first linear polarizer 806a is positioned such that at least a portion of a first collected light beam (collected for the first detector element 470a of the first set of detector elements 470a-470b) passes through the first linear polarizer 806a.

The first linear polarizer 806a may be part of the polarizer layer 450 or may be positioned at another location within the optical measurement system 800 as may be desired. The first linear polarizer 806a may be configured in any manner as described herein (e.g., to filter out light having the launch polarization or the non-launch polarization) to alter the optical path distribution of light that is incident on the first detector element 470a. For example, in the variation shown in FIG. 8, the first linear polarizer 806a is configured to filter out light having the launch polarization, which may increase the incident median path length compared to the collected median path length for the first detector element 470a. In the variation shown in FIG. 8, the second detector element 470b of the first set of detector elements 470a-470b is not filtered, such that the optical path distribution of a second collected light beam (collected for the second detector element 470b) is the same as the optical path distribution of light incident on the second detector element 470b. In other variations, the second detector element 470b may be filtered by an additional linear polarizer of the set of linear polarizers 806a-806b.

In some variations, the set of polarizers 806a-806b includes one or more additional linear polarizers that are positioned to filter light collected for detector elements that are associated with different condenser lenses. For example, in the variation shown in FIG. 8, the set of polarizers 806a-806b further includes a second linear polarizer 806b that is positioned to filter at least a portion of a collected light beam that is collected for the second detector element 474b of the third set of detector elements 474a-474b. In these variations, the optical measurement system 800 is configured to collect a third set of collected light beams for the third set of detector elements 474a-474b, and the second linear polarizer 806b is positioned such that at least a portion of a second collected light beam (collected for the second detector element 474b of the third set of detector elements 474a-474b) passes through the second linear polarizer 806b.

The second linear polarizer 806b may be part of the polarizer layer 450, or may be positioned at another location within the optical measurement system 800. The second linear polarizer 806b may be configured in an manner as described herein (e.g., to filter out light having the launch polarization or the non-launch polarization) to alter the path length distribution of light that is incident on the second detector element 474b of the third set of detector elements 474a-474b. For example, in the variation shown in FIG. 8, the second linear polarizer 806b is configured to filter out light having the non-launch polarization, which may decrease the incident median path length compared to the collected median path length for the second detector element 474b of the third set of detector elements 474a-474b. In the variation shown in FIG. 8, the first detector element 474a of the third set of detector elements 474a-474b is not filtered, such that the path length distribution of a first collected light beam of the third set of collected light beams (collected for the first detector element 474a) is the same as the path length distribution of light incident on the first detector element 474a. In other variations, the first detector element 474a may be filtered by an additional linear polarizer of the set of linear polarizers 806a-806b.

FIGS. 9A-9C depict different examples of how one or more linear polarizers may be used to light collected by a set of detector elements, where the set of detector elements receive light from a common condenser lens. For example, FIG. 9A shows a portion of a variation of an optical measurement system 900 that includes an array of detector elements that includes a first set of detector elements 904a-904b and a second set of detector elements 908. The optical measurement system 900 is configured emit an input light beam (not shown) that is linearly polarized with a launch polarization direction as it exits the optical measurement system 900, and may include a light beam generator and a launch linear polarizer to generate the input light beam as described in more detail herein. The optical measurement system 900 may include a condenser lens (not shown), such that light collected by the optical measurement system 900 for detector elements of the set of detector elements 904a-904b and the second set of detector elements 908 passes through the condenser lens. For example, the first and second sets of detector elements may be part of the arrays of detector elements of any of the detector assemblies described herein with respect to FIGS. 4A-4C.

Each of first set of detector elements 904a-904b may be laterally spaced from the light beam generator (and thereby spaced the input light beam) by a common first distance along a first dimension (e.g., the X-axis shown in FIG. 9A), and may each have a common collected optical path distribution. Specifically, the first set of detector elements 904a-904b includes a plurality of detector elements that includes at least a first detector element 904a and a second detector element 904b. The first detector element 904a and the second detector element 904b may be laterally spaced from each other along a second dimension perpendicular to the first dimension (e.g., the Y-axis shown in FIG. 9A), and may each have a common first width. The optical measurement system may be configured to collect a first set of collected light beams, where the first set of collected light beams includes a first collected light beam that is collected for the first detector element 904a and a second collected light beam that is collected for the second detector element 904b. The first set of collected beams each have a common optical path distribution as described herein.

The optical measurement system 900 includes a set of linear polarizers that includes plurality of linear polarizers 906a-906b, each of which is positioned to filter a corresponding collected light beam of the first set of collected light beams. The plurality of linear polarizers 906a-906b includes at least i) a first linear polarizer 906a that is positioned to filter the first collected light beam that is collected for the first detector element 904a of the first set of detector elements 904a-904b, and ii) a second linear polarizer 906b that is positioned to filter the second collected light beam that is collected for the second detector element 904b of the first set of detector elements 904a-904b. The first linear polarizer 906a and the second linear polarizer 906b have orthogonal polarizations. The first set of detector elements 904a-904b and the first plurality of linear polarizer 906a-906b may be configured in any manner as described herein with respect to the first set of detector elements 604a-604b and the first plurality of linear polarizers 606a-606b of FIGS. 6A and 6B.

The second set of detector elements 908, which in the variation shown in FIG. 9A includes a single detector element 908, may each be laterally spaced from the from the light beam generator along the first dimension by a second distance different than the first distance. Accordingly, the optical measurement system 900 may collect a second set of collected light beams having a different optical path distribution (e.g., a different path length distribution and/or sampling depth distribution) that the common optical path distribution of the first set of collected light beams. In some variations, the array of detector elements may include one or more additional sets of detector elements that are also positioned to receive light from the same condenser lens.

FIG. 9B shows a portion of another variation of an optical measurement system 910 that includes an array of detector elements that includes multiple sets of detector elements, each of which is positioned to receive light through from a common condenser lens. The optical measurement system 910 may be configured the same as the optical measurement system 900 of FIG. 9A, except that the depicted detector elements have been replaced by a first set of detector elements 914a-914b and a second set of detector elements 918a-918b that are collectively positioned to receive light through a common condenser lens. In this variation, each detector element of the first set of detector elements 914a-914b is laterally spaced from the light beam generator along a first dimension (e.g., the X-axis shown in FIG. 9B) by a common first distance, and is laterally spaced from each of the second set of detector elements 918a-918b along a second dimension perpendicular to the first dimension (e.g., along the Y-axis shown in FIG. 9B).

The first set of detector elements 914a-914b includes a plurality of detector elements having a common first width, and the optical measurement system 900 is configured to collect, for the first set of detector elements 914a-914b, a first set of collected light beams having a common path length distribution and a common sampling depth distribution. In the variation shown in FIG. 9B, the first set of detector elements 914a-914b includes a first detector element 914a and a second detector elements 914b. The optical measurement system 910 further includes a set of linear polarizers that includes at least a first linear polarizer 916a and a second linear polarizer 916b having orthogonal polarization directions. The first linear polarizer 916a and the second linear polarizer 916b are positioned to filter respective collected light beams that are collected for the first detector element 914a and the second detector elements 914b of the first set of detector elements 914a-914b, such as described herein with respect to the optical measurement system 600 of FIG. 6A.

The second set of detector elements 918a-918b includes at least one detector element that has a width different than the common first width and is laterally spaced from each the first set of detector elements 914a-914b along the second dimension. For example, in the variation shown in FIG. 9B, the second set of detector elements 918a-918b includes a first detector element 918a and a second detector element 918b. While shown in FIG. 9B as having a common second width that is less than the common first width, the first detector element 918a and a second detector element 918b may have respective different widths (each of which may be different than the first width). Because the second set of detector elements 918a-918b are laterally spaced from the first set of detector elements 914a-914b along the second dimension, the optical measurement system may collect light having similar path lengths and/or sampling depths for the different sets of detector elements. While each of the first detector element 918a and the second detector element 918b of the second set of detector elements 918a-918b is shown in FIG. 9B as not being filtered by the set of linear polarizers, it should be appreciated that some or all of the second set of detector elements 918a-918b may be filtered by linear polarizers of the set of linear polarizers, thereby adjust the incident optical path distributions for these detector elements.

FIG. 9C shows a portion of another variation of an optical measurement system 920 that includes an array of detector elements that includes multiple sets of detector elements positioned to receive light through from a common condenser lens. The optical measurement system 920 may be configured the same as the optical measurement system 900 of FIG. 9A, except that the depicted detector elements have been replaced by a first set of detector elements 924a-924b and a second set of detector elements 928a-928b that are collectively positioned to receive light through a common condenser lens. In this variation, each detector element of the first set of detector elements 924a-924b is laterally spaced from the light beam generator along a first dimension (e.g., the X-axis shown in FIG. 9C) by a common first distance and laterally spaced from each other along a second dimension perpendicular to the first dimension (e.g., along the Y-axis shown in FIG. 9C). Each of the second set of detector elements 928a-928b is laterally spaced from the light beam generator along the first dimension by a common second distance that is different from the first distance, and are laterally spaced from each other along the second dimension.

The first set of detector elements 924a-924b includes at least a first detector element 924a and a second detector element 924b, and the second set of detector elements 928a-928b includes at least a first detector element 928a and a second detector element 928b. The optical measurement system 920 may include a set of linear polarizers that includes a first set of linear polarizers and a second set of linear polarizers, where the first and second sets of linear polarizers have orthogonal polarization directions. The first set of linear polarizers, which is shown in FIG. 9C as a single first linear polarizer 926a but could be multiple separate linear polarizers having a common first polarization direction, is positioned to filter corresponding collected light beams that are collected for the first detector elements 924a, 928a of each of the first and second sets of detector elements. The second set of linear polarizers, which is shown in FIG. 9C as a single second linear polarizer 926b but could be multiple separate linear polarizers having a common second polarization direction, is positioned to filter corresponding collected light beams that are collected for the second detector elements 924b, 928b of each of the first and second sets of detector elements.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An optical measurement system comprising:
a light beam generator and a launch linear polarizer configured to emit a linearly polarized input light beam having a launch polarization;
a plurality of detector elements comprising a first detector element and a second detector element; and
a set of linear polarizers, wherein:
the optical measurement system is configured to collect:
a first collected light beam for the first detector element that has a first collected optical path distribution; and
a second collected light beam for the second detector element that has a second collected optical path distribution different than the first collected optical path distribution;
the set of linear polarizers comprises a first linear polarizer positioned to linearly polarize at least a portion of the first collected light beam;
a first incident optical path distribution of light incident on the first detector element is different than the first collected optical path distribution; and
a second incident optical path distribution of light incident on the second detector element is the same as the second collected optical path distribution.

2. The optical measurement system of claim 1, wherein:
the first collected light beam has a first collected median path length; and
the second collected light beam has a second collected median path length that is longer than the first collected median path length.

3. The optical measurement system of claim 2, wherein:
the plurality of detector elements comprises a third detector element;
the optical measurement system is configured to collect a third collected light beam for the third detector element that has a third collected optical path distribution; and
the third collected light beam has a third collected median path length that is longer than the second collected median path length.

4. The optical measurement system of claim 3, wherein:
the set of linear polarizers comprises a second linear polarizer positioned to linearly polarize at least a portion of the third collected light beam.

5. The optical measurement system of claim 4, wherein the first linear polarizer and the second linear polarizer have orthogonal polarization directions.

6. The optical measurement system of claim 2, wherein:
the second linear polarizer is positioned to linearly polarize a first portion of the third collected light beam; and
a second portion of the third collected light beam is not filtered by the set of linear polarizers.

7. The optical measurement system of claim 6, wherein:
the first portion of the third collected light beam has a shorter median path length than a median path length of the third collected light beam; and
the second linear polarizer is configured to filter light having the launch polarization.

8. The optical measurement system of claim 2, wherein:
the first linear polarizer is positioned to linearly polarize a first portion of the first collected light beam; and
a second portion of the first collected light beam is not filtered by the set of linear polarizers.

9. The optical measurement system of claim 8, wherein:
the first portion of the first collected light beam has a shorter median path length than a median path length of the second portion of the first collected light beam; and
the first linear polarizer is configured to filter light having a non-launch polarization.

10. An optical measurement system comprising:
a light beam generator and a launch linear polarizer configured to emit a linearly polarized input light beam having a launch polarization;
a plurality of detector elements comprising a first set of detector elements; and
a set of linear polarizers, wherein:
the first set of detector elements comprises a first detector element and a second detector element;
the optical measurement system is configured to collect a first set of collected light beams for the first set of detector elements, wherein the first set of collected light beams comprises:
a first collected light beam that has a common first collected optical path distribution and is collected for the first detector element of the first set of detector elements; and
a second collected light beam that has the common first collected optical path distribution and is collected for the second detector element of the first set of detector elements; and
the set of linear polarizers comprises a first linear polarizer positioned to linearly polarize at least a portion of the first collected light beam of the first set of collected light beams.

11. The optical measurement system of claim 10, wherein:
the set of linear polarizers comprises a second linear polarizer positioned to linearly polarize at least a portion of the second collected light beam of the first set of collected light beams.

12. The optical measurement system of claim of claim 11, wherein:
the first linear polarizer and the second linear polarizer have orthogonal polarization directions.

13. The optical measurement system of claim of claim 12, wherein:
the first detector element of the first set of detector elements outputs a first measurement signal;
the second detector element of the first set of detector elements outputs a second measurement signal; and
the optical measurement system is configured to electrically combine the first measurement signal and the second measurement signal to generate a combined measurement signal.

14. The optical measurement system of claim of claim 13, comprising:
an operational amplifier, wherein:
a first input of the operational amplifier receives the first measurement signal;
a second input of the operational amplifier receives the second measurement signal; and
an output of the operation amplifier generates the combined measurement signal.

15. The optical measurement system of claim 10, wherein:
the first set of detector elements comprises a third detector element; and
the first set of collected light beams comprises a third collected light beam that has the common first collected optical path distribution and is collected for the third detector element of the first set of detector elements.

16. The optical measurement system of claim 15, wherein:
light incident on the third detector element of the first set of detector elements has an incident optical path distribution that is the same as the common first collected optical path distribution.

17. The optical measurement system of claim 10, wherein:
the plurality of detector elements comprises a second set of detector elements; and
the optical measurement system is configured to collect a second set of collected light beams for the second set of detector elements; and
the second set of collected light beams has a common second optical path distribution different than the common first collected optical path distribution.

18. An optical measurement system comprising:
a light beam generator and a launch linear polarizer configured to emit a linearly polarized input light beam having a launch polarization;
a first condenser lens;
a plurality of detector elements comprising a first set of detector elements positioned to receive light from the first condenser lens; and
a set of linear polarizers, wherein:
the first set of detector elements comprises a first detector element and a second detector element;
the optical measurement system is configured to collect:
a first collected light beam for the first detector element of the first set of detector elements; and
a second collected light beam for the second detector element of the first set of detector elements;
the set of linear polarizers comprises a first linear polarizer positioned to linearly polarize at least a portion of the first collected light beam.

19. The optical measurement system of claim 18, wherein:
the first collected light beam and the second collected light beam each have a common first optical path distribution.

20. The optical measurement system of claim 18, wherein:
the plurality of detector elements comprises a second set of detector elements positioned to receive light from the first condenser lens.
